(19) United States
(12) Patent Application Publication
(10) Pub. No.: US 2024/0192120 A1
(43) Pub. Date: Jun. 13, 2024

(54) SYSTEMS AND METHODS FOR PREPARING IMAGING AND ANALYZING CYTOLOGIC SAMPLES

(71) Applicant: INVENIO IMAGING, INC., Santa Clara, CA (US)

(72) Inventors: Christian Wilhelm FREUDIGER, Santa Clara, CA (US); Steven PASTORE; Jay TRAUTMAN, Santa Clara, CA (US)

(21) Appl. No.: 18/392,546

(22) Filed: Dec. 21, 2023

Related U.S. Application Data
(63) Continuation of application No. PCT/US22/35835, filed on Jun. 30, 2022.
(60) Provisional application No. 63/217,461, filed on Jul. 1, 2021.

(51) Int. Cl. G01N 15/1434; G01N 1/38; G01N 1/40; G01N 15/01; G01N 15/10

(52) U.S. Cl. CPC G01N 15/1434; G01N 1/38; G01N 1/4077; G01N 15/01; G01N 2001/4088; G01N 2015/1006

(57) ABSTRACT

The present disclosure provides methods and systems for preparing, imaging, analyzing, and reprocessing biopsy or other cytologic samples for digital imaging. Systems and methods provided herein are directed towards digital imaging of a biological sample that allow for greater efficiency in time by imaging samples of biological analytes adhered to filter paper.

### CROSS-REFERENCE

This application is a continuation of International Patent Application PCT/US22/35835, filed Jun. 30, 2022, which claims benefit of U.S. Provisional Application No. 63/217,461, filed Jul. 1, 2021, each of which is incorporated herein by reference in its entirety.

### BACKGROUND

Fine needle aspiration (FNA) and fine needle biopsy (FNB) rely on small gauge needles (typically in the range from gauge 19 to gauge 24), which are favored over more invasive core needle biopsies (typically in the range from gauge 9 to gauge 18). FNAs and FNBs typically generate an aspirate of target cells intermixed with blood and blood clots. Blood clots in the sample can render the sample inadequate for downstream diagnosis assays, and can invalidate cell counts.

To account for this, a portion of the aspirates are often analyzed at the time of biopsy using a cytology technique called rapid on-site evaluation (ROSE) to establish adequacy of the specimen for downstream diagnosis and molecular characterization. ROSE entails smearing the specimen onto a microscope slide followed by fixation and staining with a rapid stain, such as Pap stain or Diff Quik, to highlight cellular and histologic level features that can be interpreted by a cytologist or cytopathologist using a conventional transmission microscope. Additional needle passes are typically collected for specimen purification and fixation to create a cell block that can be analyzed by a pathologist using morphological and immunochemistry stains, to establish a final diagnosis for the patient.

Recent advances in digital pathology imaging and machine learning (ML) learning, through artificial intelligence (AI), are promising tools to establish adequacy of the specimen. But limited imaging speed and variability in sample preparation for digital pathology imaging pose limitations. Thus, there is a need for methods that constitute a novel approach to preparing FNA/FNB samples for digital imaging to concentrate the specimen in a defined imaging area, reduce the impact of nondiagnostic portions of tissue, maintain the yield of the diagnostic specimen, preserve the specimen for molecular analysis, is near real-time, requires minimal training of the operator, and can be carried out on-site or at the bedside.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### SUMMARY OF THE INVENTION

Disclosed herein are methods comprising preparing and imaging a cytologic sample, the methods comprising the steps of: (a) dispersing a cytologic sample in a preparation solution to prepare a sample solution; (b) filtering the sample solution by directing the sample solution through a flow channel intersected by a filter, thereby generating a layer of analytes adhered to the filter; (c) mounting the layer of analytes adhered to the filter using a carrier; and (d) generating a digital microscopic image of the layer of analytes adhered to the filter, thereby imaging the cytologic sample. In some embodiments, the dispersing the cytologic sample comprises applying mechanical agitation. In some embodiment, the dispersing the cytologic sample comprises vortexing, ultrasonic actuation, aspiration, or any combination thereof. In some embodiments, generating the digital microscopic image comprises performing stimulated Raman scattering (SRS) microscopy. In some embodiments, generating the digital microscopic image comprises performing florescent microscopy. In some embodiments, the generating the digital microscopic image is accomplished by at least one of: stimulated Raman scattering (SRS) microscopy, coherent anti-Stokes Raman scattering (CARS) microscopy, fluorescent microscopy (FM), deconvolution microscopy (DM), confocal fluorescence (CF) microscopy, confocal reflection (CR) microscopy, multiphoton fluorescence microscopy (MPM), light-sheet microscopy (LSM), microscopy with ultraviolet surface excitation (MUSE), or structured light illumination microscopy (SLIM).

In some embodiments of the present disclosure, the layer of analytes adhered to the filter comprises a layer of cells. In some cases, the filter and the carrier are adjacent after said mounting. In some cases, the layer of analytes and the carrier are adjacent after said mounting.

In some embodiments, the preparation solution comprises water. In some cases, the preparation solution comprises saline. In some cases, the preparation solution comprises a phosphate buffer. In some cases, the preparation solution comprises phosphate buffered saline. In some embodiments, the preparation solution comprises an agent for lysing cells. In some cases, the agent for lysing cells comprises ammonium chloride, acetic acid, glacial acetic acid, potassium carbonate, CytoLyt solution, CytoRich solution, or any combination thereof. In some cases, the preparation solution comprises an agent for fixing cells. In some cases, the agent for fixing the cells comprises methanol, ethanol, formaldehyde, formalin, acetone, Glutaraldehyde, Osmium tetroxide, Potassium Dichromate, Mercuric Chloride, Zenker's fixative, Helly's fixative, Bouin's Fixative, Carnoy's fixative, or Saccomanno Fluid, or any combination thereof. In some cases, the preparation solution further comprises at least one fluorescent contrast agent. For example, the at least one fluorescent contrast agent can comprise one or more of: 4′,6-diamidino-2-phenylindole, DAPI, acridine orange, DRAQ5, eosin Y, fluorescein, Thiazine dye, methylene blue, azure A, Hoechst 33342, rhodamine, CellLight nucleus-cfp, NucBlue, CellLight Histone 2B-GFP, CellLight Nucelue-GIP, Syto 9 Green, CellLight Histon 2B-RFP, CellLight Nucelus-RFP, Propidium Iodide, Syto 82 Orange, SytoX Orange, NucReld Live 647, Syto 59 Red, or oil red, or any combination thereof.

Methods and systems of the present disclosure may comprise diluting a cytologic sample prior to filtration. In some cases, the cytologic sample is dispersed by a method comprising vortexing, ultrasonic actuation, aspiration, or any combination thereof.

In some embodiments, systems and methods of the present disclosure can comprise applying a positive pressure, applying a negative pressure, applying gravity, or a combination thereof in the filtering the dispersed sample. In some cases, filtering the sample solution comprises using a syringe or a pump to the apply positive pressure. In some cases, filtering the sample solution comprises using suction to apply the negative pressure. In some cases, the applying gravity comprises filtering the sample solution comprises using centrifuging.

In some cases, the filtering the sample solution comprises applying positive pressure. The positive pressure can include values in the range of 1 millibar to 10 millibar, 10 millibar to 100 millibar, 100 millibar to 1 bar, 1 bar to 10 bar, or 10 bar to 100 bar. In some cases, the filtering comprises applying negative pressure. The negative pressure can include values in the range of 1 millibar to 10 millibar, 10 millibar to 100 millibar, or 100 millibar to atmospheric pressure.

Embodiments of the present disclosure comprise filtering a dispersed sample using a filter. In some cases, the filter has a pore size in the range of 1 μm, 2 μm, 3 μm, 4 μm, 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, 20 μm, 25 μm, 30 μm, 40 μm, or 50 μm. In some cases, the filter can comprise a cellulose acetate filter, a mixed cellulose esters (MCE) filter, a polycarbonate filter, a pvp-free polycarbonate filter, a MilliPore filter, or a NuclePore filter.

In some embodiments, methods provided herein further comprise interpreting the microscopic image by a human reader to determine at least one of: adequacy of the sample, presence of tumor in the sample, or diagnosis, or any combination thereof. In some cases, the methods comprise transmitting the digital images of the specimen to an interpreter. In some cases, the methods (and systems employing the methods) further comprises analyzing the microscopic image by means of a computer-assisted image interpretation to determine at least one of adequacy of the sample, presence of tumor in the sample, or diagnosis, or any combination thereof. In some cases, the computer-assisted image interpretation is based on a convolutional neuronal network. In some cases, the computer-assisted image interpretation comprises creating image patches of individual or clusters of cells for further analysis.

In some cases, methods of the present disclosure, and systems for implementing such methods, comprise re-processing the sample for immunochemistry or molecular or cytogenic techniques. In some embodiments, the immunochemistry or molecular or cytogenic techniques comprise DNA sequencing, RNA sequencing, PCR assay, or any combination thereof.

In some cases, the re-processing comprises re-suspending the filter with the sample in a re-processing solution. In some cases, the re-processing further comprises applying mechanical agitation. In some cases, the applying mechanical agitation comprises agitating the sample solution via vortexing, ultrasonic actuation, or aspiration, or any combination thereof.

The present disclosure further provides systems for use in implementing the methods provided herein. For example, in some embodiments, the present disclosure provides a system for imaging a cytologic sample, comprising: (a) a sample preparation sub-system comprising: (i) a mixing chamber configured to disperse analytes from the cytologic sample into a preparation solution located therein, thereby generating a dispersed sample; and (ii) a filtration unit connectively coupled to the mixing unit and configured to pass the dispersed sample through a filter to generate a layer of analytes adhered to the filter; (b) at least one optical sub-system operably connected to the sample-preparation sub-system, comprising an optical-imaging modality configured to generate a digital image of the layer of analytes adhered to the filter. In some cases, the system further comprises: a processor operatively coupled to the at least one optical sub-system and configured to run an image interpretation algorithm that processes the images acquired using the optical-sectioning imaging modality to identify individual cells and determine their locations.

In some cases, the processor is configured to display the digital image of the layer of analytes adhered to the filter. In some cases, the processor is configured to transmit the digital image of the layer of analytes adhered to the filter. In some cases, the processor is configured to analyze the digital image of the layer of analytes adhered to the filter. In some cases, the processor is configured to analyze the digital image of the layer of analytes adhered to the filter using a convolutional neural network (CNN). In some cases, the processor is configured to analyze the digital image to determine sample adequacy. In some cases, the processor is configured to analyze the digital image to provide a diagnosis. In some cases, the processor is configured to analyze the digital image to identify the presence of a tumor in the cytologic sample. In some cases, the systems provided herein further comprise a pre-processor connectively coupled to the processor, wherein the pre-processor is configured to create patches of the digital image of the magnified cytologic sample.

In some cases, the digital image of the layer of analytes shows individual cells or clusters of cells.

In some cases, the systems further comprise a robotic system for transferring the filter to the imaging system. In some cases, systems provided herein further comprise a re-processing chamber operably coupled to the sample-preparation sub-system and the at least one optical sub-system, wherein the re-processing chamber is configured to suspend the filter and the layer of analytes adhered to the filter in a re-processing solution.

In some cases, the filter comprises at least one of mixed cellulose esters (MCE) filter, a polycarbonate filter, a pvp-free polycarbonate filter, a MilliPore filter, or a NuclPore filter, or any combination thereof. In some cases, the filtration unit further comprises a means for applying pressure for filtration. For example, in an embodiment, the means for applying pressure for filtration comprises a pump. In one embodiment, the means for applying pressure for filtration comprises a syringe attached to a removable filter holder.

In some embodiments of the present disclosure, the optical imaging modality is configured to image the layer of analytes in transmission. In some embodiments, the optical imaging modality is configured to image the layer of analytes in reflection.

In some cases, the sample preparation sub-system further comprises a mechanical agitator for enhanced dispersion of the cytologic sample in the preparation solution. In some embodiments, the mechanical agitator comprises a vortexer.

In some embodiments of the present disclosure, the system further comprises a container for a re-processing solution into which the filter with cytologic sample can be loaded after digital imaging.

### BRIEF DESCRIPTION OF THE DRAWINGS

The following detailed description of embodiments of the invention will be better understood when read in conjunction with the appended drawings. It should be understood that the invention is not limited to the precise arrangements and instrumentalities of the embodiments shown in the drawings.

FIG. 1 shows generally example methods of collection and testing of biological tissue samples via fine needle aspiration (FNA) and fine needle biopsy (FNB) for cytology testing. Examples of the illustrated cytology testing include adequacy assessment, diagnostic evaluation, molecular and cytogenic testing, and immunohistochemistry, including rapid on-site evaluation (ROSE) assays.

FIG. 2 illustrates an example method for preparing, imaging, analyzing, and reprocessing biopsy samples for digital imaging.

FIG. 3A through FIG. 3B depict example method for commercially available liquid-based biological tissue sample preparation techniques. FIG. 3A shows an example method for SurePath, a commercially available liquid-based biological tissue sample preparation technique. FIG. 3B shows an example method for ThinPrep, a commercially available liquid-based biological tissue sample preparation technique.

FIG. 4 shows examples of various methods and geometries for mounting a filter and adhered biological tissue sample on a carrier to create a suitably flat surface for microscopic imaging.

FIG. 5 illustrates an example of a method for re-processing a biological tissue sample after digital imaging, which may be optimized for preserving the sample for future testing.

FIG. 6A and FIG. 6B depict an example of a system method that may automate biological tissue sample preparation. FIG. 6A shows the load and dispense step and the filtration step of the system method. FIG. 6B shows the image and analysis step and the re-processing step of the system method.

### DETAILED DESCRIPTION

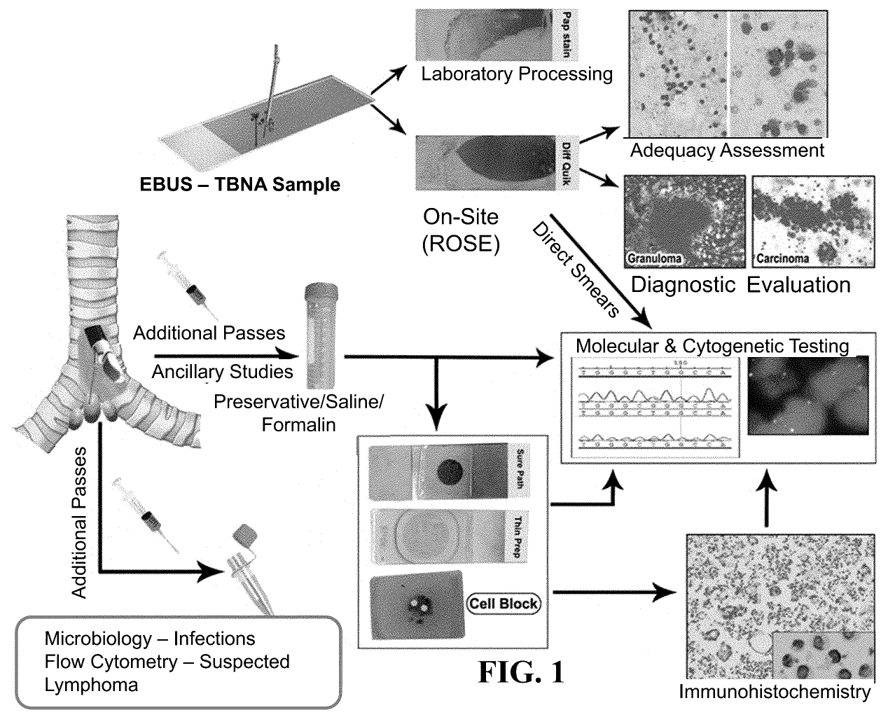

Recently, molecular and cytogenetic testing has played an increasingly important diagnostic role, in addition to morphology-based techniques. Some molecular and cytogenic testing techniques can be incompatible with the processing steps typically used in morphology-based approaches, such as fixation and staining, and thus often require additional sampling for adequacy assessment. In response, rapid on-site evaluation (ROSE) has been used to establish adequacy of a cytologic sample for downstream diagnosis and molecular characterization. FIG. 1 provides the purpose and algorithmic flow of ROSE for endobronchial ultrasound-guided transbronchial needle aspirate specimens, as an illustration of a technique for adequacy assessment.

Adequacy assessment plays an important role to inform adequate collection of specimens for downstream analysis while minimizing complications from superfluous biopsies. However, the diagnostic accuracy and convenience of ROSE is operator and institution dependent and there is a need for a more automated and quantitative approach for on-site imaging. Recent advances in digital pathology imaging and machine learning (ML) learning through artificial intelligence (AI) are a promising solution. However, limited imaging speed and variability in the sample preparation pose limitations. Therefore, there is a need for a novel approach to preparing FNA/FNB samples for digital imaging. Such an approach needs to concentrate the specimen in a defined imaging area, reduce the impact of nondiagnostic portions of tissue such as red blood cells and blood clots, maintain the yield of the diagnostic specimen, preserve the specimen for molecular analysis, is near real-time, meaning for example less than one minute in obtaining results, requires minimal training of the operator, and can be carried out on-site or at the bedside. The present disclosure addresses this need.

The present disclosure provides methods and systems for preparing, imaging, analyzing, and reprocessing biopsy samples for use in digital imaging. Before the present invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number which, in the context in which it is presented, provides the substantial equivalent of the specifically recited number.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an” and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

While the method and system has or will be described for the sake of grammatical fluidity with functional explanations, it is to be expressly understood that the claims, unless expressly formulated under 35 U.S.C. § 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 U.S.C. § 112 are to be accorded full statutory equivalents under 35 U.S.C. § 112.

### Definitions

Unless defined otherwise, all technical and scientific terms used herein have the same meaning as commonly understood by one of ordinary skill in the art to which the invention pertains. In describing and claiming the present invention, the following terminology will be used.

It is also to be understood that the terminology used herein is for the purpose of describing particular embodiments only, and is not intended to be limiting.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass non-limiting variations of ±40% or ±20% or ±10%, ±5%, ±1%, or ±0.1% from the specified value, as such variations are appropriate.

A “disease” is a state of health of an animal wherein the animal cannot maintain homeostasis, and wherein if the disease is not ameliorated then the animal's health continues to deteriorate. In contrast, a “disorder” in an animal is a state of health in which the animal is able to maintain homeostasis, but in which the animal's state of health is less favorable than it would been the absence of the disorder. Left untreated, a disorder does not necessarily cause a further decrease in the animal's state of health.

The terms “individual,” “subject,” “host,” and “patient,” are used interchangeably herein and refer to any mammalian subject for whom diagnosis, treatment, or therapy is desired, particularly humans.

“Sample” or “biological sample” are used herein to mean a biological material isolated from a subject. For example, Such a sample may refer to a cytologic sample. The biological sample may contain any biological material suitable for detecting a mRNA, polypeptide or other marker of a physiologic or pathologic process in a subject, and may comprise fluid, tissue, cellular and/or non-cellular material obtained from the individual.

Tissue Specimens: In some instances, the disclosed systems and methods may be used for characterization of any of a variety of tissue specimens known to those of skill in the art. Examples include, but are not limited to, connective tissue, epithelial tissue, muscular tissue, lung tissue, pancreatic tissue, breast tissue, kidney tissue, liver tissue, prostate tissue, thyroid tissue, and nervous tissue specimens. In some instances, the tissue specimen may be derived from any organ or component of a plant or animal. In some instances, the tissue specimen may be derived from any organ or other component of the human body including, but not limited to, the brain, heart, lungs, kidneys, liver, stomach, bladder, intestines, skeletal muscle, smooth muscle, breast, prostate, pancreas, thyroid, etc. In some instances, the tissue specimen may comprise a specimen collected from a patient exhibiting an abnormality or disease, e.g. a tumor or a cancer (e.g., sarcomas, carcinomas, gliomas, etc.).

Contrast agents: In some instances, the disclosed methods and systems comprise the use of contrast agents for enhancing and/or differentiating the appearance of neoplastic tissue, benign tissue, and malignant tissue in images of tissue specimens. As used herein, the terms “contrast agent” and “optical contrast agent” are used interchangeably. As used herein, the terms “fluorescent contrast agent” and “phosphorescent contrast agent” refer to subsets of optical contrast agents that emit fluorescence or phosphorescence respectively when properly excited. Examples of fluorescent contrast agents include, but are not limited to, 5-aminolevulinic acid hydrochloride (5-ALA), BLZ-100, and LUM015. In some instances, the disclosed methods and systems comprise the measurement of a signal derived from a contrast agent, e.g., a cell-associated contrast agent, which may be a signal generated by the contrast agent itself or by a metabolized or processed form thereof.

5-ALA is a compound that is metabolized intracellularly to form the fluorescent protoporphyrin IX (PPIX) molecule. The exogenous application of 5-ALA leads to a highly selective accumulation of PPIX in tumor cells and epithelial tissues. PPIX is excited with blue light (excitation maxima at about 405 nm and 442 nm) and emits in the red (emission maxima at about 630 nm and 690 nm) (see, e.g., Wang, et al. (2017), “Enhancement of 5-aminolevulinic acid-based fluorescence detection of side population-defined glioma stem cells by iron chelation”, Nature Scientific Reports 7:42070).

BLZ-100 comprises the tumor ligand chlorotoxin (CTX) conjugated to indocyanine green (ICG), and has shown potential as a targeted contrast agent for brain tumors, etc. (see, e.g., Butte, et al. (2014), “Near-infrared imaging of brain tumors using the Tumor Paint BLZ-100 to achieve near-complete resection of brain tumors”, Neurosurg Focus 36 (2):ET). BLZ-100 is typically excited in the near-infrared at about 780 nm (the broad ICG absorption peak being centered at approximately 800 nm), with the broad fluorescence emission spectrum (having an emission maximum at approximately 810 nm-830 nm) nearly overlapping the absorption spectrum.

LUM015, is a protease-activated imaging agent comprising a commercially-available fluorescence quencher molecule (QSY® 21) attached through a Gly-Gly-Lys-Arg (GGRK) peptide to a 20-kD polyethylene glycol (PEG) and a Cyanine dye 5 (Cy5) fluorophore. The intact molecule is optically inactive, but upon proteolytic cleavage by cathepsins K, L, or S, etc., the quencher is released to create optically active fragments (see, e.g., Whitley, et al. (2016) “A mouse-human phase 1 co-clinical trial of a protease-activated fluorescent probe for imaging cancer”, Science Translational Medicine 8(320) pp. 320ra4). The Cy5-labeled fragment has a fluorescence excitation peak at about 650 nm and an emission peak at 670 nm.

Contrast agents may be applied to tissue specimens for ex vivo imaging using any of a variety of techniques known to those of skill in the art, e.g., by applying a solution of the contrast agent to a tissue section as a staining reagent. Contrast agents may be administered to subjects, e.g., patients, for in vivo imaging by any of a variety of techniques known to those of skill in the art including, but not limited to, orally, by intravenous injection, etc., where the choice of technique may be dependent on the specific contrast agent.

For any of the imaging methods and systems disclosed herein, the tissue specimen may in some instances be stained with one or more optical contrast agents. For example, in some instances, the tissue specimen may be stained with one, two, three, four, or more than four different optical contrast agents.

As noted, in some instances, the one or more optical contrast agents may comprise fluorescent contrast agents that emit fluorescence signals. In some instances, the one or more optical contrast agents may comprise phosphorescent contrast agents that emit phosphorescence signals. In some instances, the one or more optical contrast agents may comprise contrast agents that specifically associate with cells in the tissue specimen. In some instances, the one or more optical contrast agents may comprise contrast agents that specifically associate with one or more specific types of cells (e.g., “targeted” cells). In some instances, the one or more optical contrast agents may comprise, e.g., an antibody conjugated to a fluorophore, a quantum dot, a nanoparticle, or a phosphor. In some instances, the cell-associated contrast agent may comprise a fluorogenic enzyme substrate designed to target cell types that express a specific enzyme.

High-resolution, optically-sectioned fluorescence and related imaging microscopies: High-resolution optical imaging techniques suitable for visualizing the distribution of fluorescent contrast agents in thick tissue specimens without physically sectioning the tissue include, but are not limited to, confocal fluorescence microscopy (CFM). In general, these techniques rely on, e.g., confocal optics and/or the tight focusing of excitation laser beams required to stimulate two photon fluorescence and other optical processes for achieving small depth of field that enables optically-sectioned imaging of thick tissue specimens. Some of these techniques are compatible with other optical emission modes, such as phosphorescence, as well as fluorescence.

Confocal fluorescence microscopy: Confocal fluorescence microscopy (CFM) is an imaging technique that provides three-dimensional optical resolution by actively suppressing laser-induced fluorescence signals coming from out-of-focus planes. This is typically achieved by using a pinhole in front of the detector such that light originating from an in-focus plane is imaged by the microscope objective and passes the pinhole, whereas light coming from out-of-focus planes is largely blocked by the pinhole (see, e.g., Combs (2010), “Fluorescence Microscopy: A Concise Guide to Current Imaging Methods”, Curr. Protocols in Neurosci. 50(1):2.1.1-2.1.14; Sanai, et al. (2011), “Intraoperative confocal microscopy in the visualization of 5-aminolevulinic acid fluorescence in low-grade gliomas”, J. Neurosurg. 115(4):740-748; Liu, et al. (2014), “Trends in Fluorescence Image-guided Surgery for Gliomas”, Neurosurgery 75(1): 61-71).

High-resolution, optically-sectioned non-fluorescence imaging microscopies: High-resolution optically-sectioned non-fluorescence imaging microscopies suitable for imaging tissue morphology include but are not limited to: stimulated Raman scattering (SRS) microscopy, coherent anti-Stokes Raman scattering (CARS) microscopy, and confocal reflection (CR) microscopy. In general, these techniques rely on the tight focusing of excitation laser beams required to stimulate SRS, CARS, or CR scattering or emission to achieve the small depth of field that enables optically-sectioned imaging of thick tissue specimens.

Stimulated Raman scattering (SRS) microscopy: Stimulated Raman scattering (SRS) microscopy is an imaging technique that provides rapid, label-free, high-resolution microscopic imaging of unprocessed tissue specimens. SRS microscopy requires two laser pulse trains that are temporally overlapped such that the temporal mismatch is less than the pulse duration (e.g., less than 100 fsec), and spatially overlapped by less than the focal spot size (e.g., less than 100 nm). The imaging of the stimulated Raman scattering induced in the sample by the pair of spatially and temporally synchronized laser pulse trains enables mapping of distinct molecule components within the tissue specimen based on image acquisition at the vibrational frequencies (or wavenumbers) corresponding to, for example, the CH₂-vibration of lipid molecules (2,850 cm⁻¹) or the CH₃-vibration of protein and nucleic acid molecules (2,930 cm⁻¹) (see, e.g., Freudiger, et al. (2008), “Label-Free Biomedical Imaging with High Sensitivity by Stimulated Raman Scattering Microscopy”, Science 322:1857-186; and Orringer, et al. (2017), “Rapid Intraoperative Histology of Unprocessed Surgical Specimens via Fibre-Laser-Based Stimulated Raman Scattering Microscopy”, Nature Biomed. Eng. 1:0027).

Coherent anti-Stokes Raman scattering (CARS) microscopy: Coherent anti-Stokes Raman scattering (CARS) microscopy is a label-free imaging technique which forms images of structure in samples, e.g., tissue specimens, by displaying the characteristic intrinsic vibrational contrast arising from the molecular components of the sample (see, e.g., Camp, et al. (2014), “High-speed coherent Raman fingerprint imaging of biological tissues”, Nat. Photon. 8, 627-634; and Evans, et al. (2007), “Chemically-selective imaging of brain structures with CARS microscopy”, Opt. Express. 15, 12076-12087). The technique uses two high-powered lasers to irradiate the sample, where the frequency of the first laser is typically held constant and the frequency of the second is tuned so that the frequency difference between the two lasers is equal to the frequency of a Raman-active mode of interest. CARS is orders of magnitude stronger than typical Raman scattering.

Confocal reflection (CR) microscopy: Confocal reflection microscopy, performed using a confocal microscope to take advantage of the optical sectioning capabilities of the confocal optics while operating in reflectance mode rather than fluorescence mode, may be used to image unstained tissues or tissues labeled with probes that reflect light. Near-infrared confocal laser scanning microscopy, for example, uses a relatively low-power laser beam focused tightly on a specific point in the tissue. Only light that is back-scattered from the focal plane is detected, with contrast caused by native variations in the refractive index of tissue microstructures. (see, e.g., Gonzalez, et al. (2002), “Real-time, in vivo confocal reflectance microscopy of basal cell carcinoma”, J. Am. Acad. Dermatol. 47(6):869-874).

Ranges: throughout this disclosure, various aspects can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 2, 1 to 3, 1 to 4, 1 to 5, 2 to 3, 2 to 4, 2 to 5, 2 to 6, etc., as well as individual numbers within that range, for example, 1, 2, 2.7. 3, 4, 5, 5.3, and 6. This applies regardless of the breadth of the range.

The present disclosure provides systems and methods for preparing, imaging, analyzing, and reprocessing cytologic samples. In some embodiments, the present disclosure provides methods of imaging a cytologic sample comprising: (a) dispersing a cytologic sample in a preparation solution to prepare a sample solution; (b) filtering the sample solution by directing the sample solution through a flow channel intersected by a filter, thereby generating a layer of analytes adhered to the filter; (c) mounting the layer of analytes adhered to the filter using a carrier; and (d) generating a digital microscopic image of the layer of analytes adhered to the filter, thereby imaging the cytologic sample.

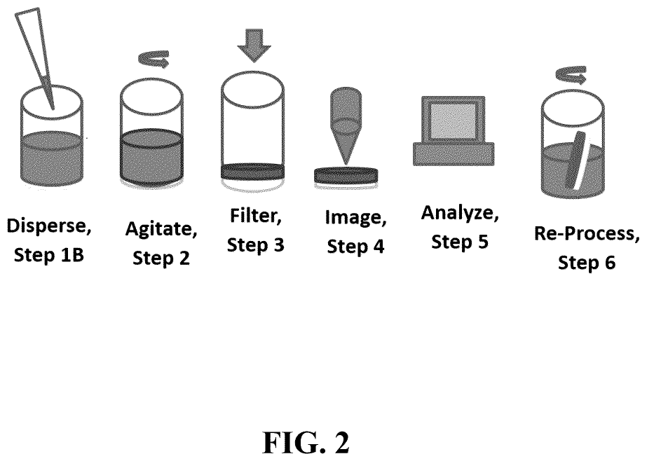

An exemplary embodiment of the present disclosure is outlined in FIG. 2. FIG. 2 shows, from left to right, the steps of: dispersion (Step 1B) aided by agitation (Step 2); filtering (Step 3); imaging (Step 4); analysis (Step 5); and re-processing (Step 6) for samples in preparation for digital imaging. The samples are first dispersed in a preparation solution by means of mechanical agitation to homogenize the sample and disperse blood clots. The sample is procured by the physician using the standard clinical methods for FNA, FNB, or core biopsy (Step 1A, not shown). The sample can then be dispersed (Step 1B) in a preparation solution, which is aided by means of mechanical agitation (e.g. vortexing, ultrasound, aspiration, etc.; Step 2) to homogenize the sample and disperse blood clots. The preparation solution can include a solvent (e.g. water, saline, or phosphate buffer) or compounds that prevent blood from clotting (e.g. heparin, ammonium oxalate) or red blood-cell lysing agents (e.g. acetic acid, glacial acetic acid, or ammonium chloride). The preparation solution can be further diluted after a certain time. The dispersed sample is then concentrated with a filter (e.g. mixed cellulose esters, cellulose acetate membrane) that collects and aggregates the cells while allowing fluid and subcellular particles to pass through uncollected (Filter, Step 3). Pore sizes can be adjusted for the specific nature of the sample. Typically, 3 um, 5 um or 8 um are suitable for cell-based samples. Such filters may already be integrated in the vial used for dispersing the sampling, as depicted in FIG. 2. Filtration can be accelerated using either positive pressure (e.g. syringe) or negative pressure (e.g. suction or vacuum) pressure or gravity (e.g. centrifugation). After filtration, the filtered sample is immediately imaged on the filter with a digital microscopic imaging system. This contrasts with transferring the sample to a coverslip or glass slide (Image, Step 4). It provides the major advantage that no sample is lost in the process, no fixation or air-drying is needed that can interfere with downstream molecular analysis, all steps can be rapidly executed and can be automated, and no sophisticated instrumentation that would preclude operation near the patient is required. Resulting images can then be quantified using computer-assisted image analysis (Analyze, Step 5). Typical output would include a determination of the adequacy of the sample, the presence of tumor cells, and diagnosis. After imaging and analysis is complete, the sample can be reprocessed for downstream analysis with standard molecular techniques (Re-Process, Step 6). Thus, no additional needle passes that can pose additional risks to the patient are required and adequacy is determined on the exact specimen that is analyzed downstream.

Cytologic samples can be procured by a physician using standard clinical methods for FNA, FNB, or core biopsy. Systems and methods provided herein involve dispersing such cytologic samples in a preparation solution by means of mechanical agitation to homogenize the same and disperse blood clots. Mechanical agitation can comprise vortexing, ultrasound, aspiration, or any combination thereof. The preparation solution, for example, can include a solvent, compounds that prevent blood from clotting, or red-blood cell lysing agents, or any combination thereof. Exemplary solvents for preparation solutions comprise water, saline, phosphate buffer, or any combination thereof. In some embodiments, the preparation solution includes one or more blood clotting preventatives, such as heparin or ammonium oxalate, potassium Ethylenediaminetetraacetic acid (EDTA), Citrate, or potassium oxalate. In some cases, the preparation solution includes Lysing agents, such as ammonium chloride, acetic acid, glacial acetic acid, potassium carbonate, or existing products such as CytoLyt solution or CytoRich solution, or any combination thereof. In some embodiments, a preparation solution is further diluted after a certain time.

In some embodiments, a dispersed sample is concentrated with a filter. In some cases, the filter comprises a cellulose acetate filter, a mixed cellulose esters (MCE) filter, a polycarbonate filter, a pvp-free polycarbonate filter, a MilliPore filter, or a NuclePore filter, or any combination thereof. The filter can collect and aggregate the cells while allowing fluid and subcellular particles to pass through uncollected. A filter's pore sizes can be selected and adjusted for the specific nature of the sample. Filter pore sizes including but not limited to 3 μm, 5 μm, or 8 μm can be used for preparing and imaging cell-based samples using systems and methods provided herein.

Systems and methods provided herein involve dispersing a cytologic sample in a preparation solution. Filters may be integrated into a vial, for example, which can be used for dispersing the sampling. Systems and methods of the present disclosure may perform filtration at different rates. For example, filtration speed can be manipulated using positive pressure, negative pressure, and/or gravity. An example of positive pressure filtration for use in systems and methods of the present disclosure involves using a syringe. An example of a negative pressure filtration mechanism for use in the present disclosure is suction or use of a vacuum. An example of gravity filtration involves using centrifugation.

The disclosed imaging methods (and systems configured to perform said methods) involve preparing a sample using a filtration method and imaging the sample without the need for transferring the sample from the filter paper. Systems and methods of the present disclosure allow for imaging of a cytologic sample immediately after filtration, and do not require removal of the sample from the filter before imaging with a digital microscopic imaging system, in contrast to methods and systems which involve transferring a sample to a coverslip or glass side. This immediate imaging can assure that no sample is lost in the process, no fixation or air-drying is needed that can interfere with downstream molecular analysis, all steps can be rapidly executed and can be automated, and no sophisticated instrumentation that would preclude operation near the patient is required. Methods and systems provided herein can be implemented for on-site testing. In some cases, systems of the present disclosure include semi-automated or fully automated solutions, or a combination thereof.

Some systems and methods provided herein can operate in a fully automated way. For example, a system can include a container of a preparation solution into which the sample can be dispersed by an operator. The system can include a subsystem for mechanically agitating the sample in preparation solution in order to disperse the sample. Such a subsystem may perform vortexing as the mechanism for mechanical agitation.

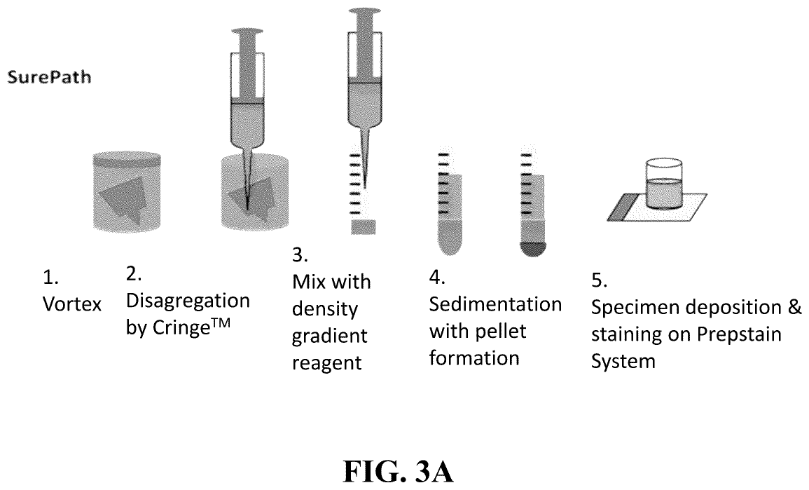

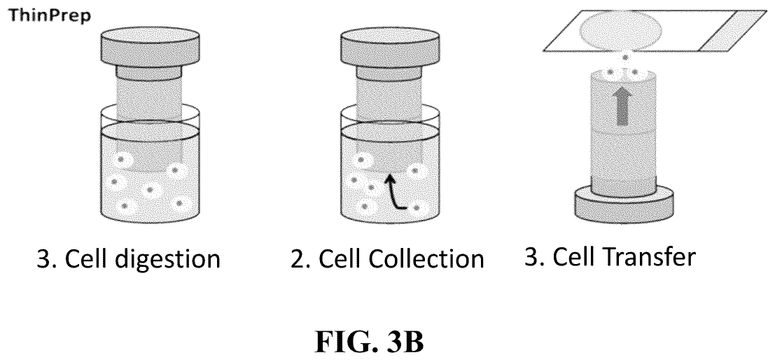

The systems and methods of the present disclosure allow for reprocessing of a sample for downstream analysis with standard molecular techniques after imaging and analysis is complete. Thus, no additional needle passes that can pose additional risks to the patient are required and adequacy is determined on an exact specimen that is analyzed downstream. The present disclosure provides advantages over commercially-available techniques, notably efficiency due to less sample loss during transfer and time saved by imaging the sample directly on the filter. FIG. 3A and FIG. 3B show exemplary commercially available liquid-based cytology techniques. FIG. 3A shows the method involved in utilizing SurePath, a technique in which concentration of the specimen is accomplished by centrifugation and sedimentation. Specifically, FIG. 3A shows the method steps of SurePath, which are vortexing, disaggregation, mixing with a density gradient reagent, sedimenting with pellet formation, and depositing the specimen and staining on a Prepstain System. FIG. 3B shows the method involved in utilizing ThinPrep, a technique in which concentration of the specimen is accomplished by negative pressure filtration followed by gentle positive air pressure adherence of the sample cells to a slide. Specifically, FIG. 3B shows the method steps of ThinPrep, which are cell dispersion, cell collection, and cell transfer.

The present disclosures provides systems and methods involving digital microscopic imaging of a cytologic samples. Digital microscopic imaging of cell and tissue samples can be achieved through a variety of imaging techniques, including but not limited to whole slide imaging (WSI), stimulated Raman scattering (SRS) microscopy, coherent anti-Stokes Raman scattering (CARS) microscopy, fluorescent microscopy (FM), deconvolution microscopy (DM), confocal fluorescence (CF) microscopy, confocal reflection (CR) microscopy, multiphoton fluorescence microscopy (MPM), light-sheet microscopy (LSM), microscopy with ultraviolet surface excitation (MUSE), or structured light illumination microscopy (SLIM), or any combination thereof. In some embodiments, an image contrast can be based on absorption, such as WSI or SRS, or emission, such as CARS, FM, DM, CF, CR, MPM, LSM, MUSE, or SLIM, and such techniques can work in transmission, such as WSI or SRS, or reflection, such as CARS, FM, DM CF, CR, MPMP, LSM, MUSE, or SLIM of a sample. In some embodiments, an image contrast can be based on intrinsic properties of the sample, such as SRS, CARS or CR, or extrinsic dyes, stains or fluorophores, such as WSI, FM, DM, CF, MPM, SLM, MUSE, or SLIM. In some embodiments, common dyes in pathology and cytology can be used, including but not limited to Hematoxylin & Eosin (H&E), Diff Quick, Pap Stain, Periodic-acid Schiff (PAS), Trichrome, or Acid Fast, or any combination thereof. In some embodiments, common intravital fluorophores can be used, including but not limited to DAPI, acridine orange, DRAQ5, eosin Y, fluorescein, Thiazine dye, methylene blue, azure A, Hoechst 33342, rhodamine, CellLight nucleus-cfp, NucBlue, CellLight Histone 2B-GFP, CellLight Nucelue-GIP, Syto 9 Green, CellLight Histon 2B-RFP, CellLight Nucelus-RFP, Propidium Iodide, Syto 82 Orange, SytoX Orange, NucReld Live 647, Syto 59 Red, or oil red, or any combination thereof.

A subset of the methods for digital imaging in the present disclosure includes optical sectioning, allowing for suppression of out-off-focus signal. Optical sectioning can be achieved via optical excitation such as SRS, CARS, MPM, LSM, or MUSE, filtering of the emission such as CF or CR, or computationally such as DM or SLIM. Methods and systems of the present disclosure can perform digital imaging via Stimulated Raman Scattering (SRS), which uses fiber lasers, providing label/stain free, three-dimensional imaging of biological specimens using intrinsic spectroscopic contrast. Digital imaging using SRS can provide near real-time imaging in the operating room (OR) with minimal sample preparation while preserving the specimen for down-stream molecular analysis. Additionally, digital imaging using SRS in conjunction with systems and methods of the present disclosure can be applied to cohesive surgical tissue biopsies which can be compressed into an imaging chamber.

In some embodiments, systems and methods provided herein utilize a traditional cytological technique to immobilize samples, including but not limited to smearing, air-drying, or alcohol fixation of the specimen, or any combination thereof. For example, methanol or ethanol used as alcohols for alcohol fixation.

Some embodiments of systems and methods provided herein involve centrifuging a sample before imaging and analyzing the same. In such embodiments, the sample is centrifuged to create a denser cell pellet, which can be extracted and imaged. Extraction methods for use in the present disclosure includes gel-based extraction methods or filter-based methods. An exemplary filter-based methods for sample extraction and preparation involves attaching a wet filter to a slide with stainless steel clips and immersing the filter in alcohol for at least 10 minutes to fix a sample.

In some embodiments, a commercially-available, liquid-based cytology technique is used to extract and prepare a sample. In such embodiments, the commercially-available technique can comprise, for example, ThinPrep, Surepath, or any combination thereof. For example, a specimen can be centrifuged and sedimented to concentrate said specimen in preparation for ThinPrep. In some cases, a specimen is adhered to a slide through a filter membrane using gentle positive air pressure in preparation for SurePath. Cells adhered to the filter directly can be imaged using transmission SRS microscopy without transferring a sample to a coverslip or microscope slides.

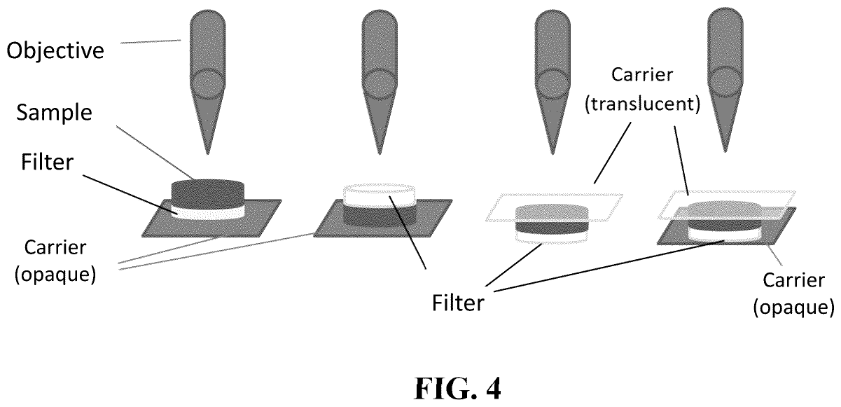

In some embodiments, the filter with analytes of the cytologic sample adhered thereto is mounted on a carrier to create a flat surface for microscopic imaging. FIG. 4 shows the various geometries that were used for mounting the filter, including mounting the filter on a carrier on the opposite side of the objective lens or the same side as the objective lens, as well as mounting the sample either facing towards or away from the carrier with respect to the filter. As shown in FIG. 4, the filter and sample can be fully enclosed by a translucent carrier.

In some cases, a filter is mounted on a carrier on the opposite side of an objective lens for imaging. In some cases, a sample faces towards the carrier with respect to a filter. In some cases, a sample faces away from the carrier. In some cases, a carrier can be translucent to allow imaging with the carrier placed on top of the filter, such that the objective lens is furthest from the filter/sample adhered thereto. For example, in some embodiments, the translucent carrier is placed directly over the layer of analytes on the filter, such that the filter is furthest away from the objective lens relative to the layer of analytes and the carrier. Exemplary carriers for use with the present disclosure include a Fisherbrand No. 1 Coverslip. Systems and methods provided herein may also involve use of two carriers, such that a filter and sample are fully enclosed to facilitate fluid immersion of the sample.

The present disclosure further provides systems for use in implementing the methods provided herein. For example, in some embodiments, the present disclosure provides a system for imaging a cytologic sample, comprising: (a) a sample preparation sub-system comprising: (i) a mixing chamber configured to disperse analytes from the cytologic sample into a preparation solution located therein, thereby generating a dispersed sample; and (ii) a filtration unit connectively coupled to the mixing unit and configured to pass the dispersed sample through a filter to generate a layer of analytes adhered to the filter; (b) at least one optical sub-system operably connected to the sample-preparation sub-system, comprising an optical-imaging modality configured to generate a digital image of the layer of analytes adhered to the filter. In some cases, the system further comprises: a processor operatively coupled to the at least one optical sub-system and configured to run an image interpretation algorithm that processes the images acquired using the optical-sectioning imaging modality to identify individual cells and determine their locations.

Imaging Systems: Imaging techniques for use with the systems and methods of sample preparation may include fluorescent microscopy. For example, an intravital dye can be added to the preparation solution to allow for fluorescence microscopy. An exemplary intravital dye comprises acridine orange in a preparation solution. In some cases, a preparation solution further comprises phosphate buffered saline. Systems and methods of the present disclosure which employ an intravital dye can involve adjusting the concentration of an intravital dye based on any specific applications. In some embodiments, an additional dilution step is performed after a certain time for staining. The additional dilution step may be automated. Any cells adhered to a filter paper can be imaged with a home-built, epi-fluorescence microscope.

Methods and systems of the present disclosure involve filtering a solution comprising a cytologic sample homogenously dispersed in preparation solution, filtering the solution such that biologically-relevant analytes (e.g., cells) adhere to the filter, and imaging the biologically-relevant analytes directly on the filter. In methods and systems of the present disclosure, imaging comprises the use of a high resolution, optically-sectioned microscopy technique including, but not limited to, confocal fluorescence microscopy or SRS microscopy to acquire images. In an exemplary embodiment, images are acquired at one, two, or more than two detection wavelengths (or within one, two, or more than two detection wavelength ranges) using excitation light at one, two, or more than two excitation wavelengths (or within one, two, or more than two excitation wavelength ranges).

In some embodiments, a contrast agent is added to the preparation solution and, after generating an image of a cytologic sample prepared according to the disclosure provided herein, an image interpretation algorithm is employed to detect contrast-positive cells based on size, shape, pattern or intensity and exclude background signals, e.g., highly-fluorescent granules based on size, shape, pattern or intensity, to provide a quantitative measure of the signal arising from a cell-associated contrast agent, where the quantitative measure of the signal is resolved at the cellular level. In some instances, the image interpretation algorithm provides a qualitative and/or quantitative measure derived from the signal(s) associated with one or more optical contrast agents, including as an average signal derived from the cell-associated contrast agent. The image interpretation algorithm may provide an average signal for the contrast-positive cells after subtracting out a background signal averaged over the entire image. The image interpretation algorithm may provide the number of cells for which the signal is greater than a specified signal threshold that defines a contrast-positive cell. In some instances, the image interpretation algorithm may provide the percentage of total cells in the image that are contrast-positive. In some instances, the disclosed methods and systems may be used during a surgical procedure to identify locations for performing a biopsy or to determine if resection is complete. For example, in some instances, the image interpretation algorithm provides a “cellularity score”, e.g., a determination of the number of cells (or cell nuclei), or the algorithm presents results as a density per unit area of the imaged tissue specimen.

The disclosed methods (and systems configured to perform said methods) can also combine the cellular imaging of one or more contrast agents using a first optical-sectioning high-resolution microscopy such as CFM, or a first imaging modality, with a second optical-sectioning high-resolution microscopy such as SRS, CARS, or CR, or a second imaging modality, used to image the tissue morphology in the same optical focal plane of the tissue specimen independently of the presence of the one or more contrast agents. The instrument then processes the images using an image interpretation algorithm to provide the location and/or area of one or more individual cells based on the image(s) acquired using the second imaging modality, and provides a quantitative measure of the signal arising from the one or more contrast agents in the tissue specimen based on the image(s) acquired using the first modality at the location(s) and/or areas corresponding to the one or more cell(s) such that the quantitative measure of signal is resolved at the cellular level. In some instances, the instrument processes the images using an image interpretation algorithm to provide the location and/or size of one or more individual cells based on the image(s) acquired using the first imaging modality, and provides a quantitative measure of the signal arising from the one or more contrast agents in the tissue specimen based on the image(s) acquired using the first modality at the location(s) and/or areas corresponding to the one or more cell(s). In some instances, the quantitative measure may be derived from the signal arising from the one or more contrast agents at the location(s) and/or areas corresponding to the one or more cell(s), or may be derived from a signal derived from the images acquired using the second imaging modality, for example an SRS signal, at the location(s) and/or areas corresponding to the one or more cell(s), or may be derived from a combination of both signals arising from the one or more contrast agents and signals derived from the imaged acquired using the second imaging modality at the location(s) and/or areas corresponding to the one or more cell(s). In some instances, the image interpretation algorithm may provide a qualitative and/or quantitative measure derived from the signal(s) associated with one or more optical contrast agents. For example, in some instances, the image interpretation algorithm may provide: (i) a “cellularity score” as discussed above, (ii) an average signal derived from the cell-associated contrast agent, (iii) an average signal for the contrast-positive cells after subtracting out a background signal averaged over the entire image, (iv) the number of cells for which the signal is greater than a specified signal threshold that defines a contrast-positive cell, (v) the percentage of total cells in the image that are contrast-positive, or any combination thereof. In some instances, the disclosed methods and systems may be used during a surgical procedure to identify locations for performing a biopsy or to determine if resection is complete.

In some embodiments, the imaging system used to generate digital microscopic images may be, for example, a multi-channel imaging microscope that simultaneously acquires a first image at the emission wavelength of the contrast agent and a second image outside the emission wavelength of the contrast agent, and then provides the multi-channel emission signals to an image interpretation algorithm that detects cells in the first image and suppresses non-specific background signal such as auto-fluorescent background or highly-fluorescent granules based on the measured spectral characteristics, for example by ratioing or thresholding the first image using the signal data acquired in the second image, for example at the locations corresponding to one or more cells detected in the first image, or otherwise correcting signals measured in the first image by a background value determined from the second image). In some instances, multi-color images may be generated based on application of a pseudo-color algorithm to the multi-channel image data for example by assigning a contrast agent-associated signal to red and a background signal to green, to simplify human interpretation of the image. Such an approach may avoid the need for computer-assisted interpretation algorithms.

Image acquisition parameters: For any of the imaging methods and systems disclosed herein, images of tissue specimens may be acquired using a variety of image acquisition parameter settings including, but not limited to, the effective image resolution, the number of excitation wavelengths used, the number of emission wavelengths at which images are acquired, the number of images acquired over a specified period of time, the number of different imaging modalities used to acquire images that are then processed and/or combined to: (i) create multi-color or enhanced contrast images that facilitate image interpretation and the identification of, e.g., neoplastic tissue, if present in the tissue specimen, and/or (ii) to generate quantitative measures based on the signal(s) derived from one or more cell-associated contrast agents and/or signals derived from a second imaging modality, for example a non-fluorescence imaging modality such as SRS.

In some instances, the disclosed imaging systems may comprise laser scanning systems, for example systems in which an image is acquired in two dimensions by scanning or rastering a laser spot across the optical focal plane of the imaging system, and emitted or scattered light, for example two photon fluorescence or stimulated Raman scattered light is directed through the optical system to one or more photodetectors, such as photomultipliers, avalanche photodiodes, solid-state near-infrared detectors, and the like. In some instances, if the imaging system comprises two or more photodetectors, the two or more detectors may be of the same type or may be of different types. In some instances, two or more detectors of different types may differ in terms of size (diameter or cross-sectional area), integration time, signal-to-noise ratio, or sensitivity, or any combination thereof.

In some instances, the disclosed imaging systems may comprise laser scanning systems that utilize one or more image sensors or cameras. For example, in some instances, the disclosed imaging systems may comprise one, two, three, four, or more than four image sensors or cameras. In some instances, if the imaging system comprises two or more image sensors or cameras, the image sensors or cameras may be the same or may differ in terms of pixel size, pixel count, dark current, signal-to-noise ratio, or detection sensitivity, or any combination thereof. The images acquired by the two or more image sensors or cameras may thus have different image resolutions. In some instances, the one or more image sensors may have a pixel count of about 0.5 megapixel, 1 megapixel, 2 megapixels, 4 megapixels, 6 megapixels, 8 megapixels, 10 megapixels, 20 megapixels, 50 megapixels, 80 megapixels, 100 megapixels, 200 megapixels, 500 megapixels, or 1000 megapixels, or any pixel count within the range spanned by these values. In some instances, the size of the pixels within a given image sensor may be about 20 μm, 10 μm, 5 μm, 3.5 μm, 2 μm, 1 μm, 0.5 μm, or 0.1 μm, or any pixel size within the range spanned by these values. In some instances, the one or more image sensors or cameras may be configured to bin groups of individual pixels to vary the effective resolution of the images thus acquired.

In some instances, the disclosed imaging systems, either scanning systems or image sensor-based systems, may be configured to acquire a single image for each of one or more specified excitation wavelengths, emission wavelengths, and/or imaging modalities. In some instances, the disclosed systems may be configured to acquire 2, 3, 4, 5, 6, 7, 8, 9, 10, 20, 30, 40, 50, 60, 70, 80, 90, 100, or more than 100 images, or any number of images within this range, for each of one or more specified excitation wavelengths, emission wavelengths, and/or imaging modalities. In some instances, the disclosed systems may be configured to acquire video data for each of one or more specified excitation wavelengths, emission wavelengths, and/or imaging modalities.

In some instances, the disclosed imaging systems may be configured to acquire one or more images within a specified time period for each of one or more specified excitation wavelengths, emission wavelengths, and/or imaging modalities. For example, in some instances, the disclosed systems may be configured to acquire one or more images every 0.1 msec, 1 msec, 10 msec, 20 msec, 30 msec, 40 msec, 50 msec, 60 msec, 70 msec, 80 msec, 90 msec, 100 msec, 200 msec, 300 msec, 400 msec, 500 msec, 600 msec, 700 msec, 800 msec, 900 msec, 1 sec, 2, sec, 3 sec, 4 sec, 5 sec, 6 sec, 7 sec, 8 sec, 9 sec, 10 sec, 20 sec, 30 sec, 40 sec, 50 sec, 1 min, 2 min, 3 min, 4 min, 5 min, 6 min, 7 min, 8 min, 9 min, 10 min, 20 min, 30 min, 40 min, 50 min, 1 hour, 2 hours, 3 hours, 4 hours, 5 hours, 6 hours, 7 hours, 8 hours, 9 hours, 10 hours, or any time period within this range, for each of one or more specified excitation wavelengths, emission wavelengths, and/or imaging modalities. In some instances, the disclosed systems may be configured to acquire video data for each of one or more specified excitation wavelengths, emission wavelengths, and/or imaging modalities.

In some instances, the disclosed imaging systems may be configured to acquire images using an exposure time, integration time, or image capture time of about 1 msec, 5 msec, 10 msec, 25 msec, 50 msec, 75 msec, 100 msec, 250 msec, 500 msec, 750 msec, 1 sec, 2 sec, 3 sec, 4 sec, 5 sec, 6 sec, 7, sec, 8 sec, 9 sec, 10 sec, 20 sec, 30 sec, 40 sec, 50 sec, 60 sec, or more than 60 sec, or any exposure time, image capture time, or integration time within the range spanned by these values.

In some instances, including but not limited to those in which two-photon fluorescence imaging is utilized, images may be acquired using one, two, three, four, or more than four different excitation wavelengths, or wavelength ranges. In some instances, images may be acquired using excitation light of about 360 nm, 380 nm, 400 nm, 420 nm, 440 nm, 460 nm, 480 nm, 500 nm, 520 nm, 540 nm, 560 nm, 580 nm, 600 nm, 620 nm, 640 nm, 660 nm, 680 nm, 700 nm, 720 nm, 740 nm, 760 nm, 780 nm, 800 nm, 820 nm, 840 nm, 860 nm, 880 nm, 900 nm, 920 nm, 940 nm, 960 nm, 980 nm, 1000 nm, 1020 nm, 1040 nm, 1060 nm, 1080 nm, 1100 nm, 1120 nm, 1140 nm, 1160 nm, 1180 nm, or 1200 nm, where the excitation wavelength(s) used will typically be selected based on the choice of optical contrast agents used to stain the tissue specimen. In some instances, light at one, two, three, four, or more than four excitation wavelengths may be provided by one, two, three, four, or more than four lasers or other light sources. In some instances, the excitation wavelengths, or wavelength ranges, may be selected using optical glass filters, bandpass filters, interference filters, long-pass filters, short-pass filters, dichroic reflectors, monochromators, or any combination thereof.

In some instances, images may be acquired using excitation and/or emission wavelength ranges comprising a bandwidth of about 10 nm, 20 nm, 30 nm, 40 nm, 50 nm, 60 nm, 70 nm, 80 nm, 90 nm, 100 nm, or more than 100 nm. In some instances, the bandpass for excitation and/or emission wavelength ranges may be selected using optical glass filters, bandpass filters, interference filters, long-pass filters, short-pass filters, dichroic reflectors, monochromators, or any combination thereof.

In some instances, the images acquired by the disclosed imaging systems may have a lateral resolution of less than 20 μm, 15 μm, 10 μm, 9 μm, 8 μm, 7 μm, 6 μm, 5 μm, 4 μm, 3 μm, 2 μm, 1 μm, 0.5 μm, or 0.25 μm. In some instances, the lateral resolution of the disclosed imaging systems may be limited by the size of a focused laser spot.

In some instances, the images acquired by the disclosed imaging systems may have an axial resolution of less than 50 μm, 20 μm, 15 μm, 10 μm, 9 μm, 8 μm, 7 μm, 6 μm, 5 μm, 4 μm, 3 μm, 2 μm, 1 μm, or 0.5 μm. In some instances, the axial resolution of the disclosed imaging systems may be limited by the size of a focused laser spot. In some instances, the axial resolution of the disclosed imaging systems may be limited by the diameter of a pinhole aperture in a confocal optical system.

In some instances, the disclosed imaging systems are configured to acquire images of the tissue specimen at the same focal plane for two or more imaging modalities. In some instances, the focal planes for two different imaging modalities may be considered the “same” if they are offset from each other by less than 10 μm, less than 9 μm, less than 8 μm, less than 7 μm, less than 6 μm, less than 5 μm, less than 4 μm, less than 3 μm, less than 2 μm, less than 1 μm, less than 0.5 μm, or less than 0.25 μm.

In some instances, including but not limited to those for which SRS imaging is utilized, images may be acquired at one or more selected wavenumbers, or wavenumber spectral ranges that correspond to the Raman shifts for different chemical groups. In some instances, images may be acquired at one, two, three, four, or more than four different wavenumbers, or wavenumber spectral ranges. Examples of wavenumber ranges that correspond to the Raman shifts for specific chemical groups include, but are not limited to, those listed in Table 1.

TABLE 1
Examples of Raman Shifts Data for Different Chemical Groups

| Approximate | |
|---|---|
| Wavenumber Range | Group |
| 1610-1740 | Carboxylic acid |
| 1625-1680 | C═C |
| 1630-1665 | C═N |
| 1710-1725 | Aldehyde |
| 1710-1745 | Ester |
| 1730-1750 | Aliphatic ester |
| 2530-2610 | Thiol |
| 2680-2740 | Aldehyde |
| 2750-2800 | N—CH3 |
| 2770-2830 | CH2 |
| 2780-2830 | Aldehyde |
| 2790-2850 | O—CH3 |
| 2810-2960 | C—CH3 |
| 2870-3100 | Aromatic C—H |
| 2880-3530 | OH |
| 2900-2940 | CH2 |
| 2980-3020 | CH═CH |
| 3010-3080 | ═CH2 |
| 3150-3480 | Amide |
| 3150-3480 | Amine |
| 3200-3400 | Phenol |
| 3210-3250 | Alcohol |
| 3250-3300 | Alkyne |

In some instances, including but not limited to those for which SRS imaging is utilized, images may be acquired in a spectral range spanning from about 100 cm⁻¹ to about 3000 cm⁻¹. In some instances, images may be acquired in a spectral range that spans at least 100 cm⁻¹, at least 125 cm⁻¹, at least 150 cm⁻¹, at least 200 cm⁻¹, at least 250 cm⁻¹, at least 300 cm⁻¹, at least 350 cm⁻¹, at least 400 cm⁻¹, at least 450 cm⁻¹, at least 500 cm⁻¹, at least 550 cm⁻¹, at least 600 cm⁻¹, at least 650 cm⁻¹, at least 700 cm⁻¹, at least 750 cm⁻¹, at least 800 cm⁻¹, at least 900 cm⁻¹, at least 1000 cm⁻¹, at least 1100 cm⁻¹, at least 1200 cm⁻¹, at least 1300 cm⁻¹, at least 1400 cm⁻¹, at least 1500 cm⁻¹, at least 1750 cm⁻¹, at least 2000 cm⁻¹, at least 2250 cm⁻¹, at least 2500 cm⁻¹, at least 2750 cm⁻¹, or at least 3000 cm⁻¹. In some instances, images may be acquired in a spectral range that spans at most 3000 cm⁻¹, at most 2750 cm⁻¹, at most 2500 cm⁻¹, at most 2250 cm⁻¹, at most 2000 cm⁻¹, at most 1750 cm⁻¹, at most 1500 cm⁻¹, at most 1400 cm⁻¹, at most 1300 cm⁻¹, at most 1200 cm⁻¹, at most 1100 cm⁻¹, at most 1000 cm⁻¹, at most 900 cm⁻¹, at most at 800 cm⁻¹, at most 750 cm⁻¹, at most 700 cm⁻¹, at most 650 cm⁻¹, at most 600 cm⁻¹, at most 550 cm⁻¹, at most 500 cm⁻¹, at most 450 cm⁻¹, at most 400 cm⁻¹, at most 350 cm⁻¹, at most 300 cm⁻¹, at most 250 cm⁻¹, at most 200 cm⁻¹, or at most 150 cm⁻¹. In some instances, images may be acquired using a spectral range that spans, e.g., about 250 cml. Those of skill in the art will appreciate that images may be acquired in a spectral range that falls anywhere within any range bounded by any of these values, for example from a range of about 200 cm⁻¹ to a range of about 760 cm⁻¹.

Multispectral and/or multimodal imaging system components: For any of the embodiments described herein, the disclosed imaging systems may comprise one or more excitation light sources, such as solid-state lasers, fiber lasers, one or more image sensors or photodetectors such as photomultipliers, avalanche photodiodes, solid-state near-infrared detectors, charge-coupled device (CCD) sensors or cameras, CMOS image sensors or cameras, one or more scanning mirrors or translation stages, and additional optical components, such as objective lenses, additional lenses used for collimating, focusing, and/or imaging excitation and/or emission light beams, mirrors, prisms, optical filters, colored glass filters, narrowband interference filters, broadband interference filters, dichroic reflectors, diffraction gratings, monochromators, apertures, optical fibers, optical waveguides, and the like, or any combination thereof. In some instances, the disclosed imaging systems may comprise one, two, three, four, or more than four lasers that provide excitation light at one, two, three, four, or more than four excitation wavelengths. In some instances, excitation light at one, two, three, four, or more than four excitation wavelengths may be delivered to the optical focal plane through the objective lens used for imaging the tissue specimen, e.g., by using an appropriate combination of mirrors, dichroic reflectors, or beam-splitters. In some instance, excitation light at one, two, three, four, or more than four excitation wavelengths may be delivered to the optical focal plane using an optical path that does not include the objective lens used for imaging the specimen. In some instances, systems and methods of the present disclosure employ imaging systems that are configured to acquire images for two or more imaging modalities from the same optical plane within the tissue specimen. In some instances, the disclosed imaging systems are configured to acquire images for two or more imaging modalities for the same field-of-view within the tissue specimen. In some instances, the disclosed imaging systems may comprise one or more processors or computers, as will be discussed in more detail below. In some instances, an instrument designed to acquire images using a first imaging modality, such as SRS imaging, may be modified to enable simultaneous or serial acquisition of images using a second imaging modality.

A non-limiting example of a stimulated Raman scattering (SRS) imaging system that may be used in combination with the systems and methods provided herein is described by Orringer, et al. (2017), “Rapid intraoperative histology of unprocessed surgical specimens via fibre-laser-based stimulated Raman scattering microscopy”, Nature Biomed. Eng. 1:0027). The fully-integrated SRS imaging system comprised five major components: (1) a fiber-coupled microscope with a motorized stage; (2) a dual-wavelength fiber-laser module; (3) a laser control module; (4) a microscope control module; and (5) a computer for image acquisition, display, and processing. The design of the dual-wavelength fiber-laser exploited the fact that the difference frequency of the two major fiber gain media, erbium and ytterbium, overlaps with the high wavenumber region of Raman spectra. The two synchronized narrow-band laser pulse trains required for SRS imaging were generated by narrow-band filtering of a broad-band super-continuum derived from a single fiber-oscillator and, subsequently, amplification in the respective gain medium. The development of an all-fiber system based on polarization-maintaining components greatly improved laser stability over previous non-polarization-maintaining implementations. To enable high-speed diagnostic-quality imaging (e.g., 1 megapixel images acquired in about 2 seconds per wavelength) with a signal-to-noise ratio comparable to what can be achieved with solid-state lasers, the laser output power was scaled to approximately 120 mW for a fixed wavelength 790 nm pump beam and approximately 150 mW for a tunable Stokes beam over the entire tuning range from 1,010 to 1,040 nm at 40 MHz laser pulse repetition rate and 2 picosecond transform-limited laser pulse duration. Custom laser controller electronics were developed to tightly control the operational settings of the laser system using a micro-controller. A noise-cancellation scheme based on auto-balanced detection, in which a portion of the laser beam is sampled to provide a measure of the laser noise that can then be subtracted in real time, was used to further improve image quality. In some instances, a system such as the described SRS imaging system may be modified to simultaneously or serially acquire, e.g., two photon fluorescence images, by providing at least one additional excitation laser of the appropriate wavelength and at least one additional image sensor or camera, where the at least one additional excitation beam and at the emitted two photon fluorescence are coupled with the SRS imaging system using a combination of dichroic reflectors, beam splitters, etc.

Software and computer-readable media: Various aspects of the disclosed algorithms or computer-implemented methods may be thought of as “products” or “articles of manufacture” such as “computer program or software products”, typically in the form of processor executable code and/or associated data that is stored in a type of computer readable medium, where the processor executable code comprises a plurality of instructions for controlling a computer or computer system in performing one or more of the methods disclosed herein. Processor-executable (or machine-executable) code may be stored, for example, in an optical storage unit comprising an optically-readable medium such as an optical disc, CD-ROM, DVD, or Blu-Ray disc. Processor-executable code may be stored in an electronic storage unit, such as memory or on a hard disk. “Storage” type media include any or all of the tangible memory of a computer, computer system, or associated modules thereof, such as various semiconductor memory chips, optical drives, tape drives, disk drives, and the like, which may provide non-transitory storage at any time for the software that encodes the methods and algorithms disclosed herein.

All or a portion of the software code may at times be communicated via the Internet or various other telecommunication networks. Such communications, for example, may enable loading of the software from one computer or processor into another, from a management server or host computer into the computer platform of an application server. Thus, other types of media that may be used to convey the software encoded instructions include optical, electrical, and electromagnetic waves, such as those used across physical interfaces between local devices, through wired and optical landline networks, and over various atmospheric telecommunication links. The physical elements that carry such waves, such as wired or wireless links, optical links, or the like, are also considered media that convey the software encoded instructions for performing the methods disclosed herein.

Computer processors: In some instances, the disclosed imaging systems may comprise one or more processors or computers that are individually or collectively programmed to provide instrument control and/or image processing functionality according to the methods disclosed herein. In some cases, the processor is configured to display the digital image of the layer of analytes adhered to the filter. In some cases, the processor is configured to transmit the digital image of the layer of analytes adhered to the filter. In some cases, the processor is configured to analyze the digital image of the layer of analytes adhered to the filter. For example, in some cases, the processor is configured to analyze the digital image of the layer of analytes adhered to the filter using a convolutional neural network (CNN). The processor may be configured to analyze the digital image to determine sample adequacy, to provide a diagnosis, or to identify the presence of a tumor in the cytologic sample. In some cases, the systems provided herein further comprise a pre-processor connectively coupled to the processor, wherein the pre-processor is configured to create patches of the digital image of the magnified cytologic sample.

The one or more processors may comprise a hardware processor such as a central processing unit (CPU), a graphic processing unit (GPU), a general-purpose processing unit, or computing platform. The one or more processors may be comprised of any of a variety of suitable integrated circuits such as application specific integrated circuits (ASICs), or field-programmable gate arrays (FPGAs), microprocessors, emerging next-generation microprocessor designs, logic devices, and the like. Although the disclosure is described with reference to a processor, other types of integrated circuits and logic devices may also be applicable. The processor may have any suitable data operation capability. For example, the processor may perform 512 bit, 256 bit, 128 bit, 64 bit, 32 bit, or 16 bit data operations. The one or more processors may be single core or multi core processors, or a plurality of processors configured for parallel processing. In some instances, the one or more processors or computers used to implement the disclosed imaging methods may be part of a larger computer system and/or may be operatively coupled to a computer network with the aid of a communication interface to facilitate transmission of and sharing of data. The network may be a local area network, an intranet and/or extranet, an intranet and/or extranet that is in communication with the Internet, or the Internet. The network in some cases is a telecommunications and/or data network. The network may include one or more computer servers, which in some cases enables distributed computing, such as cloud computing. The network, in some cases with the aid of the computer system, may implement a peer-to-peer network, which may enable devices coupled to the computer system to behave as a client or a server.

In some instances, the disclosed imaging systems may also include memory or memory locations, electronic storage units, communication interfaces for communicating with one or more other imaging systems and/or peripheral devices such as data storage and/or electronic display adapters. In some instance, the data storage units store files, such as drivers, libraries, and saved programs. The storage units may also store user data, such as user-specified preferences, user-specified programs, and image data acquired during the testing or use of the disclosed imaging systems. The computer system or network in some cases may include one or more additional data storage units that are external to the computer system, such as data storage units located on a remote server that is in communication with the computer system through an intranet or the Internet.

Image processing and image interpretation: After imaging the cytologic sample, resulting images can then be quantified using computer-assisted image analysis. Examples of output of such an analysis include a determination of the adequacy of a sample, the presence of tumor cells, or a diagnosis, or any combination thereof. In some instances, the disclosed imaging methods may comprise the use of image processing and/or image interpretation algorithms for processing the acquired images and providing qualitative and/or quantitative measures derived from the signals associated with one or more cell-associated contrast agents and/or signals derived from non-fluorescence imaging modalities. In some instances, the image processing and/or image interpretation algorithm may process images acquired using a first imaging modality to identify cells and determine their locations. In some instances, the image processing and/or image interpretation algorithm may process images acquired using a second imaging modality that is different from the first to identify cells and determine their locations. In some instances, the image processing and/or image interpretation algorithm may process images acquired using either or both of a first and second imaging modalities to identify cells and determine their locations.

The image interpretation algorithm may comprise any of a variety of conventional image processing algorithms known to those of skill in the art. Examples include, but are not limited to, Canny edge detection methods, Canny-Deriche edge detection methods, first-order gradient edge detection methods such as the Sobel operator, second order differential edge detection methods, phase congruency, edge detection methods, other image segmentation algorithms such as intensity thresholding, intensity clustering methods, intensity histogram-based methods, feature and pattern recognition algorithms such as the generalized Hough transform for detecting arbitrary shapes, or the circular Hough transform, and mathematical analysis algorithms such as the Fourier transform, fast Fourier transform, wavelet analysis, or auto-correlation, or any combination thereof. In some instances, such image processing algorithms may be used to detect individual cells within an image based on, for example, feature size, shape, pattern, intensity, or any combination thereof.

The image interpretation algorithm may comprise an artificial intelligence or machine learning algorithm trained, for example to further refine the ability of the image processing and/or image interpretation algorithm to identify individual cells within an image and/or to differentiate between normal and non-normal tissue such as neoplastic tissue based on qualitative and/or quantitative measures that are derived from the signals derived from one or more contrast agents and/or signals derived from non-fluorescence imaging modalities.

Any of a variety of machine learning algorithms may be used in implementing the disclosed methods and systems. Examples include, but are not limited to, a supervised learning algorithm, an unsupervised learning algorithm, a semi-supervised learning algorithm, a deep learning algorithm, or any combination thereof. In some instances, the machine learning algorithm may comprise an artificial neural network algorithm, a deep convolutional neural network algorithm, a deep recurrent neural network, a generative adversarial network, a support vector machine, a hierarchical clustering algorithm, a Gaussian process regression algorithm, a decision tree algorithm, a logistical model tree algorithm, a random forest algorithm, a fuzzy classifier algorithm, a k-means algorithm, an expectation-maximization algorithm, a fuzzy clustering algorithm, or any combination thereof.

In some instances, the machine learning algorithm may be trained using one or more training data sets that comprise, for example, imaging data acquired for archived histopathological tissue samples such as formalin-fixed tissue samples or fresh frozen tissue samples, imaging data acquired for fresh histopathological tissue samples, or any combination thereof. In some instances, the training data set may be continuously, periodically, or randomly updated with imaging data acquired by two or more systems that have been deployed for use at the same or different sites. In some instances, the two or more systems are deployed at different sites, and the training data set optionally resides in a cloud-based database and/or is continuously, periodically, or randomly updated via an internet connection.

In some instances, the image interpretation algorithm provides a “cellularity score”, a determination of the number of cells or cell nuclei that are identified per unit area of the imaged sample. In some instances, the image interpretation algorithm provides an average signal derived from the cell-associated contrast agent. In some instances, the image interpretation algorithm provides an average signal for the contrast-positive cells after subtracting out a background signal averaged over the entire image. In some instances, the image interpretation algorithm provides the number of cells for which the signal is greater than a specified signal threshold that defines a contrast-positive cell. In some instances, the image interpretation algorithm provides the percentage of total cells in the image that are contrast-positive. As noted above, in some instances, the image interpretation algorithm may be configured to generate quantitative measures based on the signal(s) derived from one or more cell-associated contrast agents and/or signals derived from a second imaging modality, for example a non-fluorescence imaging modality such as SRS or one of the other non-fluorescence imaging modalities described herein.

In some instances, the imaging methods and systems of the present disclosure may comprise the use of a pseudo-color algorithm to convert images acquired using any of one or more imaging modalities to generate multicolor images that provide enhanced contrast for tissue structure, that provide for enhanced detection of neoplastic tissue, and/or that facilitate human interpretation of the image. In some instances, the use of a pseudo-color algorithm to convert images acquired using any of one or more imaging modalities may facilitate human interpretation of the image(s) without the need for implementing additional image interpretation algorithms. In some instances, the pseudo-color images generated from images acquired using any of one or more imaging modalities may then be combined to enhance contrast for tissue structure, or provide for enhanced detection of, neoplastic tissue, and/or that facilitate human interpretation of the image.

Computer-assisted techniques, such as machine learning (ML), artificial intelligence (AI), or convolutional neuronal nets (CNNs), can be utilized for interpreting and quantifying any digital images of FNA, FNB, and core biopsy samples according to the present disclosure. For example, computer-assisted techniques can be applied to SRS images generated using the present systems and methods for cohesive surgical biopsy specimens. Computer-assisted technology may aid cytologic specimen preparation disclosed herein. Systems and methods of the present disclosure can train a CNN by annotating digital images based on human interpretation. This human interpretation may be performed by a pathologist or cytologist, and may also incorporate a final diagnosis of a specimen obtained through traditional clinical means. Other computer-assisted techniques for use in the systems and methods provided herein include patch-based classification methods. In some cases, an algorithm can be trained to identify and crop individual cells imaged from the sample adhered to the filter. Such an algorithm can generate predictions based on said cropped images.

Sample Re-processing: Systems and methods of the present disclosure allow for re-processing of a sample. For example, after digital imaging, a filtered sample (i.e., the sample adhered to the filter and/or the filter paper) can be suspended in a re-processing solution. In an exemplary embodiment, the re-processing solution comprises RPMI medium. The contents of the re-processing solution can be optimized for preserving the sample for downstream molecular analysis, such as DNA sequencing, RNA sequencing, PCR, proteomic analysis, or any combination thereof. Some re-processing systems and methods provided herein also employ mechanisms of mechanical agitation to facilitate dislodging of a sample adhered to a filter. Potential exemplary mechanisms of mechanical agitation include vortexing, ultrasonic agitation, mechanical aspiration, or any combination thereof.

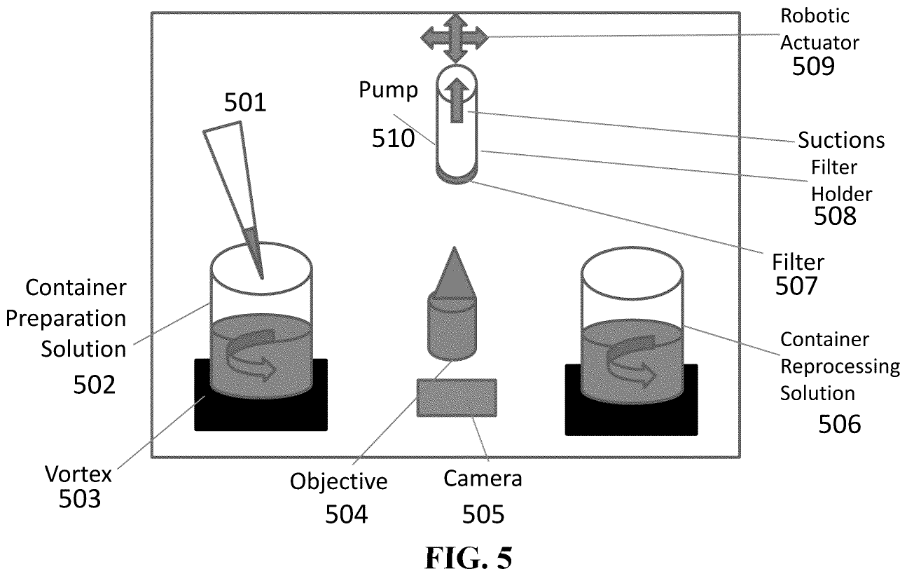

The systems of disclosure described also include systems for automating said methods of preparing, imaging, analyzing, or reprocessing an aspirate, or a combination thereof. Such systems can operate in an automated or semi-automated manner. The system can operate in a fully automated way by including a container of a preparation solution into which the sample can be dispersed by the operator and a subsystem for mechanically agitating the dispersed sample and applying positive or negative pressure to filter the dispersed sample. The system may include a transfer mechanism for transferring the filter with the filtered cytologic sample to the imaging system and automatically acquire a digital image of the magnified filtered cytologic sample, as shown in FIG. 5, which has a robotic actuator.

The schematic of the system for preparing, imaging, analyzing, and reprocessing a cytologic sample in an automated method is shown in FIG. 5. In such an embodiment, an operator disperses a cytologic sample (501) in a preparation solution (502), such as saline. In this embodiment, the pump or syringe (510) is attached to a removable Luer-lock filter holder (508), and negative pressure is applied through the syringe or pump to suction the dispersed solution through the filter (507). After filtration, a filter with any sample adhered thereto can be transferred to a digital imaging system having a camera (505) and objective (504) for immediate imaging, during which a computer system can display, transmit, or analyze, or any combination thereof, a generated digital image. This automated system illustrated in FIG. 5 vortexes the sample in a preparation solution, performs imaging via a robotic actuator (509), which suctions the solution through a filter (507), and vortexes (503) the sample in a container of reprocessing solution (506). Such systems include a filter for filtering the cytologic sample, a digital imaging system having an objective lens for capturing a digital image of the magnified view of the filtered cytologic sample, and a computer for processing the digital image of the magnified filtered cytologic sample as shown in FIG. 5.

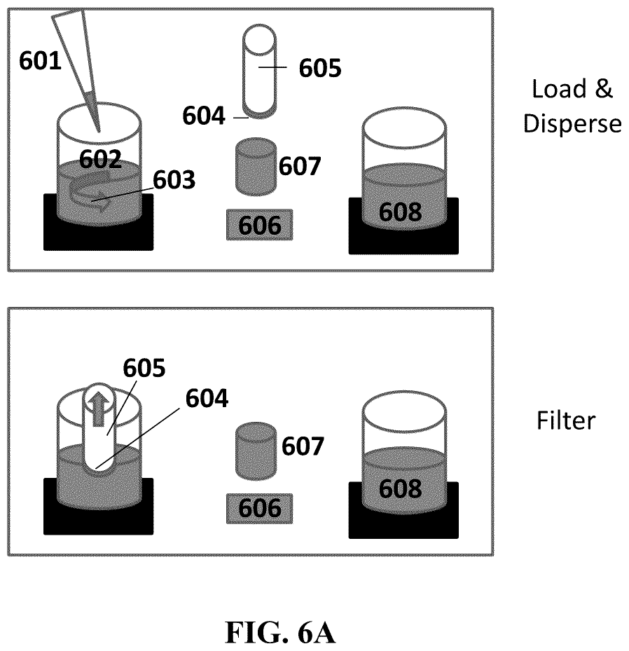

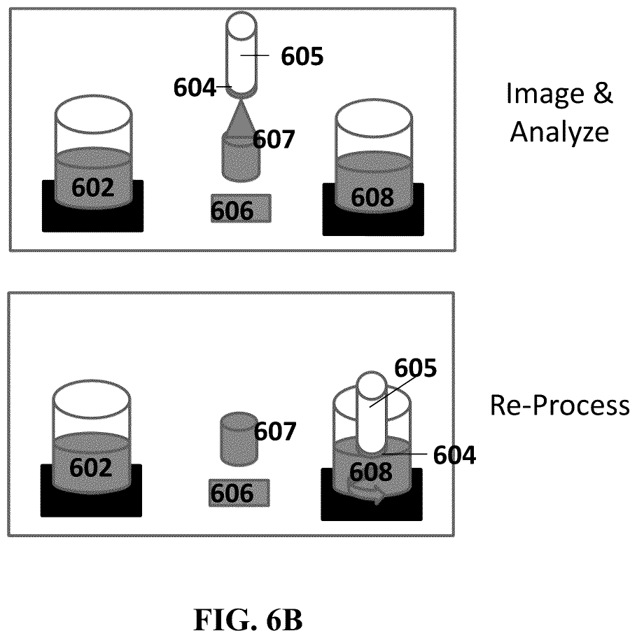

An exemplary embodiment of a semi-automated system is shown in FIG. 6A and FIG. 6B. In FIG. 6A, the first two-steps are not automated. First, the operator loads and disperses the sample (601) into preparation solution (602) via manual agitation (603). The operator then filters the dispersed sample through a syringe (604) with a filter (605) using positive or negative pressure, as shown on the left in the lower panel (“Filter” panel). The automated camera (606) and objective (607) of the imaging system are also shown, as well as the automated sub-system containing re-processing solution (608). FIG. 6B shows the automated steps of imaging and analyzing (top panel, “Image and Analzye”) as well as the operator-performed step of re-processing (bottom panel, “Re-Process”).

### LIST OF EMBODIMENTS

The following list of embodiments of the invention are to be considered as disclosing various features of the invention, which features can be considered to be specific to the particular embodiment under which they are discussed, or which are combinable with the various other features as listed in other embodiments. Thus, simply because a feature is discussed under one particular embodiment does not necessarily limit the use of that feature to that embodiment.

Embodiment 1. A method of imaging a cytologic sample, the method comprising: (a) dispersing a cytologic sample in a preparation solution to prepare a sample solution; (b) filtering the sample solution by directing the sample solution through a flow channel intersected by a filter, thereby generating a layer of analytes adhered to the filter; (c) mounting the layer of analytes adhered to the filter using a carrier; and (d) generating a digital microscopic image of the layer of analytes adhered to the filter, thereby imaging the cytologic sample.

Embodiment 2. The method of Embodiment 1, wherein the dispersing the cytologic sample comprises applying mechanical agitation.

Embodiment 3. The method of Embodiment 1 or Embodiment 2, wherein the dispersing the cytologic sample comprises vortexing, ultrasonic actuation, aspiration, or any combination thereof.

Embodiment 4. The method of any one of Embodiments 1 to 3, wherein generating the digital microscopic image comprises performing stimulated Raman scattering (SRS) microscopy.

Embodiment 5. The method of any one of Embodiments 1 to 4, wherein generating the digital microscopic image comprises performing fluorescent microscopy.

Embodiment 6. The method of any one of Embodiments 1 to 5, wherein generating the digital microscopic image is accomplished by at least one of: stimulated Raman scattering (SRS) microscopy, coherent anti-Stokes Raman scattering (CARS) microscopy, fluorescent microscopy (FM), deconvolution microscopy (DM), confocal fluorescence (CF) microscopy, confocal reflection (CR) microscopy, multiphoton fluorescence microscopy (MPM), light-sheet microscopy (LSM), microscopy with ultraviolet surface excitation (MUSE), or structured light illumination microscopy (SLIM).

Embodiment 7. The method of any one of Embodiments 1 to 6, wherein the layer of analytes comprises a layer of cells.

Embodiment 8. The method of any one of Embodiments 1 to 7, wherein the filter and the carrier are adjacent after said mounting.

Embodiment 9. The method of any one of Embodiments 1 to 8, wherein the layer of analytes and the carrier are adjacent after said mounting.

Embodiment 10. The method of any one of Embodiments 1 to 9, wherein the preparation solution comprises water.

Embodiment 11. The method of any one of Embodiments 1 to 10, wherein the preparation solution comprises saline.

Embodiment 12. The method of any one of Embodiments 1 to 11, wherein the preparation solution comprises a phosphate buffer.

Embodiment 13. The method of any one of Embodiments 1 to 12, wherein the preparation solution comprises phosphate buffered saline.

Embodiment 14. The method of any one of Embodiments 1 to 13, wherein the preparation solution further comprises an agent for lysing cells.

Embodiment 15. The method of Embodiment 14, wherein the agent for lysing cells comprises ammonium chloride, acetic acid, glacial acetic acid, potassium carbonate, CytoLyt solution, CytoRich solution, or any combination thereof.

Embodiment 16. The method of any one of Embodiments 1 to 15, wherein the preparation solution further comprises an agent for preventing clotting of cells and extracellular contents.

Embodiment 17. The method of Embodiment 16, wherein the agent for preventing clotting of cells and extracellular contents comprises heparin, ammonium oxalate, potassium Ethylenediaminetetraacetic acid (EDTA), Citrate, or potassium oxalate, or any combination thereof.

Embodiment 18. The method of any one of Embodiments 1 to 17, wherein the preparation solution further comprises an agent for fixing the cells.

Embodiment 19. The method of Embodiment 18, wherein the agent for fixing the cells further comprises methanol, ethanol, formaldehyde, formalin, acetone, Glutaraldehyde, Osmium tetroxide, Potassium Dichromate, Mercuric Chloride, Zenker's fixative, Helly's fixative, Bouin's Fixative, Carnoy's fixative, or Saccomanno Fluid, or any combination thereof.

Embodiment 20. The method of any one of Embodiments 1 to 19, wherein the preparation solution further comprises at least one fluorescent contrast agent.

Embodiment 21. The method of Embodiment 20, wherein the fluorescent contrast agent further comprises at least one of: 4′,6-diamidino-2-phenylindole, DAPI, acridine orange, DRAQ5, eosin Y, fluorescein, Thiazine dye, methylene blue, azure A, Hoechst 33342, rhodamine, CellLight nucleus-cfp, NucBlue, CellLight Histone 2B-GFP, CellLight Nucelue-GIP, Syto 9 Green, CellLight Histon 2B-RFP, CellLight Nucelus-RFP, Propidium Iodide, Syto 82 Orange, SytoX Orange, NucReld Live 647, Syto 59 Red, or oil red, or any combination thereof.

Embodiment 22. The method of claim any one of Embodiments 1 to 21, comprising diluting the sample solution prior to filtration.

Embodiment 23. The method of any one of Embodiments 1 to 22, wherein the filtering the dispersed sample comprising applying a positive pressure.

Embodiment 24. The method of any one of Embodiments 1 to 22, wherein the filtering the dispersed sample comprising applying a negative pressure.

Embodiment 25. The method of any one of Embodiments 1 to 22, wherein the filtering the dispersed sample comprising applying gravity.

Embodiment 26. The method of claim 22 or 23, wherein the filtering the dispersed sample comprises using a syringe.

Embodiment 27. The method of claim 22 or 23, wherein the filtering the dispersed sample comprises using a pump.

Embodiment 28. The method of claim 24, wherein the filtering the dispersed sample comprises using suction.

Embodiment 29. The method of claim 25, wherein the filtering the dispersed sample comprises centrifugation.

Embodiment 30. The method of claim 23, wherein the positive pressure is in the range from 1 millibar to 10 millibar, 10 millibar to 100 millibar, 100 millibar to 1 bar, 1 bar to 10 bar, or 10 bar to 100 bar.

Embodiment 31. The method of claim 24, wherein the negative pressure is in the range from 1 millibar to 10 millibar, 10 millibar to 100 millibar, or 100 millibar to atmospheric pressure.

Embodiment 32. The method of any one of Embodiments 1 to 31, wherein the filter has a pore size of 1 μm, 2 μm, 3 μm, 4 μm, 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, 20 μm, 25 μm, 30 μm, 40 μm, or 50 μm.

Embodiment 33. The method of any one of Embodiments 1 to 32, wherein the filter comprises a cellulose acetate filter, a mixed cellulose esters (MCE) filter, a polycarbonate filter, a pvp-free polycarbonate filter, a MilliPore filter, or a NuclePore filter.

Embodiment 34. The method of any one of Embodiments 1 to 33, wherein the method further comprises interpreting the microscopic image by a human reader to determine at least one of adequacy of the sample, presence of tumor in the sample, or diagnosis, or any combination thereof.

Embodiment 35. The method of any one of Embodiments 1 to 34, wherein the methods further comprises transmitting the digital images of the specimen to an interpreter.

Embodiment 36. The method of any one of Embodiments 1 to 35, wherein the method further comprises the step of analyzing the microscopic image by means of a computer-assisted image interpretation to determine at least one of: adequacy of the sample, presence of tumor in the sample, or diagnosis, or any combination thereof.

Embodiment 37. The method of claim 36, wherein the computer-assisted image interpretation is based on a convolutional neuronal network.

Embodiment 38. The method of claim 36 or claim 37, wherein the computer-assisted image interpretation comprises creating image patches of individual or clusters of cells for further analysis.

Embodiment 39. The method of any one of Embodiments 1 to 38, wherein the method further comprises re-processing the sample for immunochemistry or molecular or cytogenic techniques.

Embodiment 40. The method of claim 39, wherein the immunochemistry or molecular or cytogenic techniques comprise DNA sequencing, RNA sequencing, PCR assay, or any combination thereof.

Embodiment 41. The method of claim 40, wherein the re-processing comprises re-suspending the filter with the sample in a re-processing solution.

Embodiment 42. The method of claim 41, wherein the re-processing further comprises applying mechanical agitation.

Embodiment 43. The method of claim 42, wherein the applying mechanical agitation comprises agitating the sample solution via vortexing, ultrasonic actuation, or aspiration, or any combination thereof.

Embodiment 44. A system for use in implementing the method of any one of Embodiments 1 to 43.

Embodiment 45. A system for imaging a cytologic sample, comprising: (a) a sample preparation sub-system comprising: (i) a mixing chamber configured to disperse analytes from the cytologic sample into a preparation solution located therein, thereby generating a dispersed sample; and (ii) a filtration unit connectively coupled to the mixing unit and configured to pass the dispersed sample through a filter to generate a layer of analytes adhered to the filter; (b) at least one optical sub-system operably connected to the sample-preparation sub-system, comprising an optical-imaging modality configured to generate a digital image of the layer of analytes adhered to the filter.

Embodiment 46. The system of Embodiment 45, further comprising: a processor operatively coupled to the at least one optical sub-system and configured to run an image interpretation algorithm that processes the images acquired using the optical-sectioning imaging modality to identify individual cells and determine their locations.

Embodiment 47. The system of claim 46, wherein the processor is configured to display the digital image of the layer of analytes adhered to the filter.

Embodiment 48. The system of claim 46 or 47, wherein the processor is configured to transmit the digital image of the layer of analytes adhered to the filter.

Embodiment 49. The system of any one of Embodiments 46 to 48, wherein the processor is configured to analyze the digital image of the layer of analytes adhered to the filter.

Embodiment 50. The system of any one of Embodiments 46 to 49, wherein the processor is configured to analyze the digital image of the layer of analytes adhered to the filter using a convolutional neural network (CNN).

Embodiment 51. The system of any one of Embodiments 46 to 50, wherein the processor is configured to analyze the digital image to determine sample adequacy.

Embodiment 52. The system of any one of Embodiments 46 to 51, wherein the processor is configured to analyze the digital image to provide a diagnosis.

Embodiment 53. The system of any one of Embodiments 46 to 52, wherein the processor is configured to analyze the digital image to identify the presence of a tumor in the cytologic sample.

Embodiment 54. The system of any one of Embodiments 46 to 53, further comprising a pre-processor connectively coupled to the processor, wherein the pre-processor is configured to create patches of the digital image of the magnified cytologic sample.

Embodiment 55. The system of any one of Embodiments 46 to 54, wherein the digital image of the layer of analytes shows individual cells or clusters of cells.

Embodiment 56. The system of any one of Embodiments 46 to 55, further comprising a robotic system for transferring the filter to the imaging system.

Embodiment 57: The system of any one of Embodiments 45 to 56, further comprising: a re-processing chamber operably coupled to the sample-preparation sub-system and the at least one optical sub-system, wherein the re-processing chamber is configured to suspend the filter and the layer of analytes adhered to the filter in a re-processing solution.

Embodiment 58. The system of any one of Embodiments 45 to 57, wherein the filter comprises at least one of mixed cellulose esters (MCE) filter, a polycarbonate filter, a pvp-free polycarbonate filter, a MilliPore filter, or a NuclPore filter, or any combination thereof.

Embodiment 59. The system of any one of Embodiments 45 to 58, wherein the filtration unit further comprises a means for applying pressure for filtration.

Embodiment 60. The system of any one of Embodiments 45 to 59, wherein the means for applying pressure for filtration comprises a pump.

Embodiment 61. The system of any one of Embodiments 45 to 60, wherein the means for applying pressure for filtration comprises a syringe attached to a removable filter holder.

Embodiment 62. The system of any one of Embodiments 45 to 61, wherein the optical imaging modality is configured to image the layer of analytes in transmission.

Embodiment 63. The system of any one of Embodiments 45 to 61, wherein the optical imaging modality is configured to image the layer of analytes in reflection.

Embodiment 64. The system of any one of Embodiments 45 to 63, wherein the sample preparation sub-system further comprises a mechanical agitator for enhanced dispersion of the cytologic sample in the preparation solution.

Embodiment 65. The system of claim 64, wherein the mechanical agitator comprises a vortexer.

Embodiment 66. The system of any one of Embodiments 45 to 65, wherein the system further comprises a container for a re-processing solution into which the filter with cytologic sample can be loaded after digital imaging.

Embodiment 67. The system of any one of Embodiments 45 to 66, wherein the optical-imaging modality comprises at least one of: stimulated Raman scattering (SRS) microscopy, coherent anti-Stokes Raman scattering (CARS) microscopy, fluorescent microscopy (FM), deconvolution microscopy (DM), confocal fluorescence (CF) microscopy, confocal reflection (CR) microscopy, multiphoton fluorescence microscopy (MPM), light-sheet microscopy (LSM), microscopy with ultraviolet surface excitation (MUSE), or structured light illumination microscopy (SLIM), or any combination thereof.

### EXAMPLES

The invention is further described in detail by reference to the following experimental examples. These examples are provided for purposes of illustration only, and are not intended to be limiting unless otherwise specified. Thus, the invention should in no way be construed as being limited to the following examples, but rather should be construed to encompass any and all variations which become evident as a result of the teaching provided herein. Without further description, it is believed that one of ordinary skill in the art can, using the preceding description and the following illustrative examples, make and utilize the present invention and practice the claimed methods. The following working examples therefore are not to be construed as limiting in any way the remainder of the disclosure.

### Example 1

A few drops of human blood (≈1 mL) are dispersed in phosphate buffered saline (Sigma Aldrich). The dispersed sample is loaded into a syringe and concentrated by filtering the sample through a filter (MCE nitrocellulose membrane filters, pore size 5 μm) located at the dispensing end of the syringe. The filter collects and aggregates cells while allowing fluid and subcellular particles to pass through uncollected and exit via the syringe tip. The filter, with sample adhered thereto, is removed and mounted on an NIO Slide (Invenio Imaging Inc.), with the filter facing the NIO Slide, for imaging. Using the NIO Laser Imaging System (Invenio Imaging, Inc.), Stimulated Raman Scattering is performed with fiber lasers to provide label and stain-free three-dimensional imaging of biological specimens using intrinsic spectroscopic contrast.

### Example 2

This example extends the imaging approach (e.g., imaging the sample adhered to the filter directly) to other imaging techniques and systems. In this example, fluorescence microscopy is used to generate digital images. To do so, acridine orange (Sigma Aldrich, Acridine orange solution, 2% in water) is included in the preparation solution (phosphate buffered saline). A few drops of human blood (≈1 mL) are dispersed in phosphate buffered saline (Sigma Aldrich). The dispersed sample is loaded into a syringe and concentrated via a filter (MF-Millipore™ Membrane Filter, 8 μm pore size 19 mm×42 mm for cytology). The filter, located at the dispensing end of the syringe, collects and aggregates cells while allowing fluid and subcellular particles to pass through uncollected and exit via the syringe tip. The filter is removed and the filter with sample adhered thereto are imaged with a home-build, epi-fluorescence microscope (Basler acA2040-120uc camera, Thorlabs 470 nm LED light Source, Edmund Optics 508 nm long-pass filter, and Olympus UPlanSApo 20×Objective).

### Exemplary Non-Limiting Aspects of the Disclosure

Aspects, including embodiments, of the present subject matter described above may be beneficial alone or in combination, with one or more other aspects or embodiments. Without limiting the foregoing description, certain non-limiting aspects of the disclosure are provided below. As will be apparent to those of ordinary skill in the art upon reading this disclosure, each of the individually numbered aspects may be used or combined with any of the preceding or following individually numbered aspects. This is intended to provide support for all such combinations of aspects and is not limited to combinations of aspects explicitly provided below. It will be apparent to one of ordinary skill in the art that various changes and modifications can be made without departing from the spirit or scope of the invention.

What is claimed is:

1. A method of imaging a cytologic sample, the method comprising:
(a) dispersing a cytologic sample in a preparation solution to prepare a sample solution;
(b) filtering the sample solution by directing the sample solution through a flow channel intersected by a filter, thereby generating a layer of analytes adhered to the filter;
(c) mounting the layer of analytes adhered to the filter using a carrier; and
(d) generating a digital microscopic image of the layer of analytes adhered to the filter, thereby imaging the cytologic sample.

2. The method of claim 1, wherein dispersing the cytologic sample comprises applying mechanical agitation.

3. The method of claim 1, wherein the mechanical agitation comprises vortexing, ultrasonic actuation, aspiration, or any combination thereof.

4.-5. (canceled)

6. The method of claim 1, wherein generating the digital microscopic image is accomplished by at least one of: stimulated Raman scattering (SRS) microscopy, coherent anti-Stokes Raman scattering (CARS) microscopy, fluorescent microscopy (FM), deconvolution microscopy (DM), confocal fluorescence (CF) microscopy, confocal reflection (CR) microscopy, multiphoton fluorescence microscopy (MPM), light-sheet microscopy (LSM), microscopy with ultraviolet surface excitation (MUSE), or structured light illumination microscopy (SLIM).

7. The method of claim 1, wherein the layer of analytes comprises a layer of cells.

8. The method of claim 1, wherein the filter and the carrier are adjacent after said mounting.

9. The method of claim 1, wherein the layer of analytes and the carrier are adjacent after said mounting.

10. The method of claim 1, wherein the preparation solution comprises water, saline, a phosphate buffer, an agent for lysing cells, an agent for preventing clotting of cells and extracellular contents, an agent for fixing the cells, a fluorescent contrast agent, or a combination thereof.

11.-14. (canceled)

15. The method of claim 10, wherein: (i) the agent for lysing cells comprises ammonium chloride, acetic acid, glacial acetic acid, potassium carbonate, CytoLyt solution, CytoRich solution, or any combination thereof; (ii) the agent for preventing clotting of cells and extracellular contents comprises heparin, ammonium oxalate, potassium Ethylenediaminetetraacetic acid (EDTA), Citrate, or potassium oxalate, or any combination thereof; (iii) the agent for fixing the cells further comprises methanol, ethanol, formaldehyde, formalin, acetone, Glutaraldehyde, Osmium tetroxide, Potassium Dichromate, Mercuric Chloride, Zenker's fixative, Helly's fixative, Bouin's Fixative, Carnoy's fixative, or Saccomanno Fluid, or any combination thereof; and (iv) the fluorescent contrast agent further comprises at least one of: 4 ′,6-diamidino-2-phenylindole, DAPI, acridine orange, DRAQ5, eosin Y, fluorescein, Thiazine dye, methylene blue, azure A, Hoechst 33342, rhodamine, CellLight nucleus-cfp, NucBlue, CellLight Histone 2B-GFP, CellLight Nucelue-GIP, Syto 9 Green, CellLight Histon 2B-RFP, CellLight Nucelus-RFP, Propidium Iodide, Syto 82 Orange, SytoX Orange, NucReld Live 647, Syto 59 Red, or oil red, or any combination thereof.

16.-21. (canceled)

22. The method of claim 1, comprising diluting the sample solution prior to filtration.

23. The method of claim 1, wherein the filtering the dispersed sample comprising applying a pressure or gravity, wherein the pressure comprises a positive pressure or a negative pressure.

24.-25. (canceled)

26. The method of claim 22, wherein the filtering the dispersed sample comprises using a syringe, using a pump, or using centrifugation.

27.-32. (canceled)

33. The method of claim 1, wherein the filter comprises a cellulose acetate filter, a mixed cellulose esters (MCE) filter, a polycarbonate filter, a PVP-free polycarbonate filter, a MilliPore filter, or a NuclePore filter.

34. The method of claim 1, wherein the method further comprises analyzing the microscopic image to determine at least one of: adequacy of the sample, presence of tumor in the sample, or diagnosis, or any combination thereof.

35. (canceled)

36. The method of claim 4, wherein the analyzing the microscopic image is by a human reader or by means of a computer-assisted image interpretation, wherein the computer-assisted image interpretation is based on a convolutional neuronal network.

37. The method of claim 36, wherein the analyzing comprises determining: adequacy of the sample, presence of tumor in the sample, a diagnosis, or a combination thereof.

38. The method of claim 36, wherein the computer-assisted image interpretation comprises creating image patches of individual cells or clusters of cells for further analysis.

39. The method of claim 1, wherein the method further comprises re-processing the sample for immunochemistry or molecular or cytogenic techniques.

40. The method of claim 39, wherein the immunochemistry or molecular or cytogenic techniques comprise DNA sequencing, RNA sequencing, PCR assay, or any combination thereof.

41. The method of claim 40, wherein the re-processing comprises re-suspending the filter with the sample in a re-processing solution, wherein the re-processing further comprises applying mechanical agitation.

42.-67. (canceled)
